(19) United States
(12) Patent Application Publication
(10) Pub. No.: US 2025/0206986 A1
(43) Pub. Date: Jun. 26, 2025

(54) ADHESIVE SHEET AND MANUFACTURING METHOD THEREFOR

(71) Applicant: LINTEC CORPORATION, Tokyo (JP)

(72) Inventors: Kenta YAMAZAKI, Saitama-shi (JP); Shinya SUZUKI, Toda-shi (JP)

(73) Assignee: LINTEC CORPORATION, Tokyo (JP)

(21) Appl. No.: 18/850,119

(22) PCT Filed: Mar. 31, 2022
(86) PCT No.: PCT/JP2022/016670

§ 371 Date: Sep. 24, 2024

(51) Int. Cl. C09J 7/24; C09J 133/08

(52) U.S. Cl. CPC C09J 7/245; C09J 133/08; C09J 2301/122; C09J 2301/302; C09J 2301/41; C09J 2301/416; C09J 2427/00; C09J 2433/00

(57) ABSTRACT

A pressure sensitive adhesive sheet, including a laminate of: a substrate; and a pressure sensitive adhesive layer, where the substrate is formable by irradiating a resin film including a polymer and a hydrogen abstraction type photoinitiator with an energy ray, where the hydrogen abstraction type photoinitiator is capable of abstracting a hydrogen from the polymer, the pressure sensitive adhesive layer is formable by irradiating an energy ray-crosslinkable pressure sensitive adhesive composition layer including an energy ray-crosslinkable pressure sensitive adhesive composition with an energy ray, and the laminate of the substrate and the pressure sensitive adhesive layer is formed by irradiating a laminate of the resin film and the energy ray-crosslinkable pressure sensitive adhesive composition layer with an energy ray.

### TECHNICAL FIELD

The present invention relates to a pressure sensitive adhesive sheet and a method for producing the same.

### BACKGROUND ART

Pressure sensitive adhesive sheets are used in a wide range of industrial fields, for example, label applications for displaying various types of information; applications for fixing or temporarily fixing various components in fields such as office automation equipment, household electrical appliances, automobiles, and construction; and masking applications.

Hot melt pressure sensitive adhesives are widely used as pressure sensitive adhesives used in pressure sensitive adhesive sheets. The hot melt pressure sensitive adhesives can be applied to substrates or the like by heat-melting without using a solvent and thus have an advantage of being able to reduce environmental load in producing pressure sensitive adhesive sheets.

As the hot melt pressure sensitive adhesive, for example, a synthetic rubber-based hot melt pressure sensitive adhesive is widely known. In recent years, acrylic hot melt pressure sensitive adhesives and the like have been developed in response to an increasing need for reduction in environmental load.

For example, Patent Document 1 discloses a radiation-curable hot melt pressure sensitive adhesive containing 100 parts by weight of an acrylic polymer having a radiation reactive group, 3 to 20 parts by weight of an acrylic monomer, and 0.002 to 0.2 parts by weight of a polymerization inhibitor having a specific structure.

### CITATION LIST

### Patent Literature

Patent Document 1: JP 2015-214601 A

### SUMMARY OF INVENTION

### Technical Problem

In general, a pressure sensitive adhesive sheet is formed by laminating a substrate and a pressure sensitive adhesive layer. If the adhesion between the substrate and the pressure sensitive adhesive layer is insufficient, when the pressure sensitive adhesive sheet once attached to an adherend is detached, the substrate and the pressure sensitive adhesive layer may be detached at the interface and the pressure sensitive adhesive layer may remain on the adherend. In particular, when a low-polarity substrate such as polyvinyl chloride or polyolefin is used, such an incident is likely to occur.

Such remaining of the pressure sensitive adhesive layer on the adherend is undesirable because it brings fouling of the adherend.

The present invention has been made in light of the above-mentioned issues, and an object thereof is to provide a pressure sensitive adhesive sheet that is excellent in substrate adhesion and can be detached without fouling of an adherend.

### Solution to Problem

The inventors have found that a pressure sensitive adhesive sheet including a laminate of a specific substrate and a specific pressure sensitive adhesive layer can solve the above-mentioned issues, thereby leading to the present invention.

That is, the present invention relates to [1] to below.

[1] A pressure sensitive adhesive sheet including a laminate of a substrate and a pressure sensitive adhesive layer,
in which
the substrate is formable by irradiating a resin film containing a polymer (A) and a hydrogen abstraction type photoinitiator (B) with an energy ray, and the polymer (A) is a polymer from which the hydrogen abstraction type photoinitiator (B) is capable of abstracting a hydrogen,
the pressure sensitive adhesive layer is formable by irradiating an energy ray-crosslinkable pressure sensitive adhesive composition layer made of an energy ray-crosslinkable pressure sensitive adhesive composition with an energy ray, and
the laminate of the substrate and the pressure sensitive adhesive layer is formed by irradiating a laminate of the resin film and the energy ray-crosslinkable pressure sensitive adhesive composition layer with an energy ray.

[2] The pressure sensitive adhesive sheet according to [1], in which the polymer (A) is at least one selected from the group consisting of a polyvinyl chloride-based resin, polyolefin, an acrylic resin, and a styrene-based resin.

[3] The pressure sensitive adhesive sheet according to [1] or [2], in which the hydrogen abstraction type photoinitiator (B) contained in the resin film accounts for 10 parts by mass or less with respect to 100 parts by mass of the component (A).

[4] The pressure sensitive adhesive sheet according to any one of [1] to [3], in which the polymer (A) contained in the resin film accounts for 50 mass % or more with respect to 100% by mass of the total of components of the resin film.

[5] The pressure sensitive adhesive sheet according to any one of [1] to [4], in which the energy ray-crosslinkable pressure sensitive adhesive composition is a pressure sensitive adhesive composition (I) containing an acrylic polymer (C) having energy ray-crosslinkability, or a pressure sensitive adhesive composition (II) containing an acrylic polymer (D) other than the acrylic polymer (C) and the hydrogen abstraction type photoinitiator (B).

[6] The pressure sensitive adhesive sheet according to [5], in which the acrylic polymer (C) in the pressure sensitive adhesive composition (I) is an acrylic polymer (C1) having an energy ray-reactive group that reacts by energy ray irradiation and contributes to formation of a crosslinked structure, and the acrylic polymer (C1) is an acrylic polymer having a benzophenone structure in a side chain.

[7] The pressure sensitive adhesive sheet according to [5] or [6], in which the acrylic polymer (C) accounts for 50 to 100 mass % with respect to 100 mass % of a total amount of the pressure sensitive adhesive composition (I).

[8] The pressure sensitive adhesive sheet according to [5], in which the acrylic polymer (D) accounts for 50 mass % or more with respect to 100 mass % of a total amount of the pressure sensitive adhesive composition (II).

[9] A method for producing the pressure sensitive adhesive sheet according to any one of [1] to [8], including, in this order:
1: forming a resin film containing a polymer (A) and a hydrogen abstraction type photoinitiator (B).
2: laminating the resulting resin film and an energy ray-crosslinkable pressure sensitive adhesive composition layer made of an energy ray-crosslinkable pressure sensitive adhesive composition to form a laminate of the resin film and the energy ray-crosslinkable pressure sensitive adhesive composition layer.
3: irradiating the resulting laminate of the resin film and the energy ray-crosslinkable pressure sensitive adhesive composition layer made of the energy ray-crosslinkable pressure sensitive adhesive composition with an energy ray to form a laminate of a substrate and a pressure sensitive adhesive layer.

[10] A pressure sensitive adhesive sheet including a laminate of a resin film and
an energy ray-crosslinkable pressure sensitive adhesive composition layer made of an energy ray-crosslinkable pressure sensitive adhesive composition, in which
the resin film contains a polymer (A) and a hydrogen abstraction type photoinitiator (B), and the polymer (A) is a polymer from which the hydrogen abstraction type photoinitiator (B) is capable of abstracting a hydrogen.

[11] A resin film containing a polymer (A) and a hydrogen abstraction type photoinitiator (B),
in which
the polymer (A) is a polymer from which the hydrogen abstraction type photoinitiator (B) is capable of abstracting a hydrogen.

### Advantageous Effects of Invention

According to the present invention, it is possible to provide a pressure sensitive adhesive sheet which is excellent in substrate adhesion and can be detached without fouling of an adherend.

### BRIEF DESCRIPTION OF DRAWINGS

FIG. 1 is a schematic cross-sectional view illustrating an example of a configuration of a pressure sensitive adhesive sheet according to the present invention.

FIG. 2 is a schematic cross-sectional view illustrating another example of a configuration of a pressure sensitive adhesive sheet according to the present invention.

FIG. 3 is a schematic cross-sectional view illustrating another example of a configuration of a pressure sensitive adhesive sheet according to the present invention.

### DESCRIPTION OF EMBODIMENTS

In the present specification, the lower and upper limits of a preferable numerical range (for example, a range of content) described in series can each be independently combined. For example, from the description “preferably from 10 to 90, more preferably from 30 to 60”, the “preferred lower limit (10)” and the “more preferred upper limit (60)” can be combined as “from 10 to 60”. Moreover, for example, the same applies to the description of “preferably 10 or more, and more preferably 30 or more, and preferably 90 or less, and more preferably 60 or less”.

In the present specification, the “energy ray” means an electromagnetic wave or a charged particle beam having an energy quantum, and examples include ultraviolet rays, radiation, and electron beams. The ultraviolet rays can be irradiated by using, for example, an electrodeless lamp, a high-pressure mercury lamp, a metal halide lamp, or a UV-LED as an ultraviolet ray source. The electron beam can be generated by an electron beam accelerator or the like and irradiated. Note that the energy ray in an aspect of the present invention is preferably an ultraviolet ray among those described above.

In the present specification, “energy ray-crosslinkable” refers to a property of forming a crosslinked structure by irradiation with an energy ray.

In the present specification, “solids content” refers to a component excluding a diluent solvent, such as water or an organic solvent, from the components contained in a target composition.

In the present specification, “(meth)acryl” is used as a term meaning either or both “acryl” and “methacryl”. In the present specification, “(meth)acrylate” is used as a term meaning either or both “acrylate” and “methacrylate”. In the present specification, “(meth)acryloyl” is used as a term meaning either or both “acrylyloyl” and “methacryloyl”.

In the present specification, “weight average molecular weight (Mw)” is a value measured by gel permeation chromatography (GPC) method calibrated with polystyrene standards, and specifically is a value measured based on the method described in Examples.

The mechanism of action described in the present specification is a presumption and does not limit the mechanism exerting the effects of the present invention.

### [Pressure Sensitive Adhesive Sheet]

A first pressure sensitive adhesive sheet according to an aspect of the present invention is a pressure sensitive adhesive sheet including a laminate of a resin film and an energy ray-crosslinkable pressure sensitive adhesive composition layer made of an energy ray-crosslinkable pressure sensitive adhesive composition. The resin film contains a polymer (A) and a hydrogen abstraction type photoinitiator (B), and the polymer (A) is a polymer from which the hydrogen abstraction type photoinitiator (B) is capable of abstracting a hydrogen.

A second pressure sensitive adhesive sheet according to an aspect of the present invention is a pressure sensitive adhesive sheet including a laminate of a substrate and a pressure sensitive adhesive layer. The substrate is formable by irradiating a resin film containing a polymer (A) and a hydrogen abstraction type photoinitiator (B) with an energy ray. The polymer (A) is a polymer from which the hydrogen abstraction type photoinitiator (B) is capable of abstracting a hydrogen. The pressure sensitive adhesive layer is formable by irradiating an energy ray-crosslinkable pressure sensitive adhesive composition layer composed an energy ray-crosslinkable pressure sensitive adhesive composition with an energy ray. The laminate of the substrate and the pressure sensitive adhesive layer is formed by irradiating a laminate of the resin film and the energy ray-crosslinkable pressure sensitive adhesive composition layer with the energy ray.

In the following description, the “energy ray-crosslinkable pressure sensitive adhesive composition” is also simply referred to as a “pressure sensitive adhesive composition”. The “energy ray-crosslinkable pressure sensitive adhesive composition layer made of the energy ray-crosslinkable pressure sensitive adhesive composition” is also simply referred to as a “pressure sensitive adhesive composition layer”.

The “pressure sensitive adhesive sheet” refers to both the first pressure sensitive adhesive sheet and the second pressure sensitive adhesive sheet.

Next, an example of the configuration of the pressure sensitive adhesive sheet according to an aspect of the present invention is described using the drawings, but the pressure sensitive adhesive sheet of the present invention is not limited to the following examples.

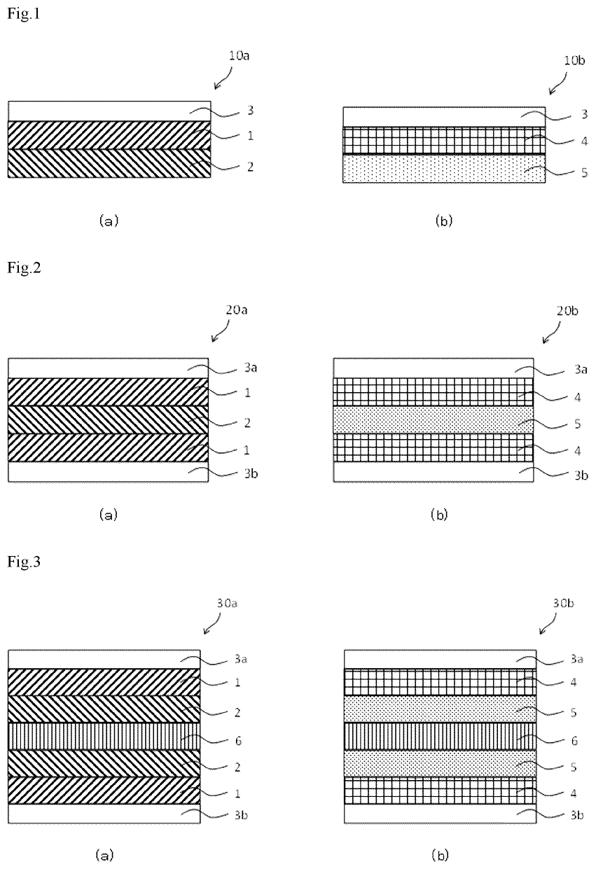

FIG. 1(a) illustrates, as an example of the first pressure sensitive adhesive sheet, a pressure sensitive adhesive sheet 10a having: the release liner 3 on one surface side of a pressure sensitive adhesive composition layer 1; and a resin film 2 on the other surface side of the pressure sensitive adhesive composition layer 1.

FIG. 1(b) illustrates, as an example of the second pressure sensitive adhesive sheet, a pressure sensitive adhesive sheet 10b having: a release liner 3 on one surface side of a pressure sensitive adhesive layer 4; and a substrate 5 on the other surface side of the pressure sensitive adhesive layer 4.

As previously mentioned, the laminate of the pressure sensitive adhesive layer 4 and the substrate 5 of the second pressure sensitive adhesive sheet is formed by irradiating the laminate of the pressure sensitive adhesive composition layer 1 and the resin film 2 of the first pressure sensitive adhesive sheet with an energy ray.

The pressure sensitive adhesive sheets 10a and 10b are suitable for applications in which, for example, the release liner 3 is detached and removed, and then the exposed surface of the pressure sensitive adhesive composition layer 1 or the pressure sensitive adhesive layer 4 is attached to an adherend. Examples of such use include use for a label.

Note that, in a case where the pressure sensitive adhesive sheet to be attached to an adherend is the first pressure sensitive adhesive sheet, after being attached to the adherend, the laminate of the substrate 5 and the pressure sensitive adhesive layer 4 in the second pressure sensitive adhesive sheet may be formed by irradiating the laminate of the resin film 2 and the pressure sensitive adhesive composition layer 1 with an energy ray.

FIG. 2(a) illustrates, as another example of the first pressure sensitive adhesive sheet, a double-sided pressure sensitive adhesive sheet 20a having: pressure sensitive adhesive composition layers 1 on both surfaces of the resin film 2; a release liner 3a on a surface of one pressure sensitive adhesive composition layer 1, the surface being on the opposite side to the resin film 2; and a release liner 3b on a surface of the other pressure sensitive adhesive composition layer 1, the surface being on the opposite side to the resin film 2.

The plurality of pressure sensitive adhesive composition layers 1 present in FIG. 2(a) may be layers made of the same component or layers made of different components.

In addition, FIG. 2(b) illustrates, as another example of the second pressure sensitive adhesive sheet, a double-sided pressure sensitive adhesive sheet 20b having: the pressure sensitive adhesive layers 4 on both surfaces of the substrate 5; the release liner 3a on a surface of one pressure sensitive adhesive layer 4, the surface being on the opposite side to the substrate 5; and the release liner 3b on a surface of the other pressure sensitive adhesive layer 4, the surface being on the opposite side to the substrate 5.

The plurality of pressure sensitive adhesive layers 4 present in FIG. 2(b) may be layers made of the same component or layers made of different components.

FIG. 3(a) illustrates, as still another example of the first pressure sensitive adhesive sheet, a double-sided pressure sensitive adhesive sheet 30a having: pressure sensitive adhesive composition layers 1 on both surfaces of a laminate including three layers of the resin film 2, a support 6, and the resin film 2; a release liner 3a on a surface of one pressure sensitive adhesive composition layer 1, the surface being on the opposite side to the resin film 2; and a release liner 3b on a surface of the other pressure sensitive adhesive composition layer 1, the surface being on the opposite side to the resin film 2.

The support 6 in FIG. 3(a) may be the resin film 2.

The plurality of pressure sensitive adhesive composition layers 1 present in FIG. 3(a) may be layers made of the same component or layers made of different components.

The plurality of resin films 2 present in FIG. 3(a) may be layers made of the same component or layers made of different components.

FIG. 3(b) illustrates, as still another example of the second pressure sensitive adhesive sheet, a double-sided pressure sensitive adhesive sheet 30b having: the pressure sensitive adhesive layers 4 on both surfaces of a laminate including three layers of the substrate 5, the support 6, and the substrate 5; the release liner 3a on a surface of one pressure sensitive adhesive layer 4, the surface being on the opposite side to the substrate 5; and the release liner 3b on a surface of the other pressure sensitive adhesive layer 4, the surface being on the opposite side to the substrate 5.

The support 6 in FIG. 3(b) may be the substrate 5.

The plurality of pressure sensitive adhesives 4 present in FIG. 3(b) may be layers made of the same component or layers made of different components.

The plurality of substrates 5 in FIG. 3(b) may be layers made of the same component or layers made of different components.

Each layer of the pressure sensitive adhesive sheet according to an aspect of the present invention and each component contained in each layer will be described in detail below.

### <Substrate>

The substrate is formable by irradiating a resin film containing a polymer (A) (hereinafter, also referred to as a “component (A)”) and a hydrogen abstraction type photoinitiator (B) (hereinafter, also referred to as a “component (B)”) with an energy ray. That is, as previously mentioned, the substrate is formable by irradiating the resin film of the first pressure sensitive adhesive sheet with an energy ray.

### (Resin Film)

A resin film according to an aspect of the present invention contains a polymer (A) and a hydrogen abstraction type photoinitiator (B), in which the component (A) is a polymer from which the hydrogen abstraction type photoinitiator (B) is capable of abstracting a hydrogen. The resin film can be used as the resin film of the first pressure sensitive adhesive sheet. As previously mentioned, the laminate of the substrate and the pressure sensitive adhesive layer of the second pressure sensitive adhesive sheet can be formed by irradiating the laminate of the resin film and the energy ray-crosslinkable pressure sensitive adhesive composition layer with the energy ray. That is, the resin film according to an aspect of the present invention can be used as a resin film for forming the substrate of the second pressure sensitive adhesive sheet.

### [Polymer (A)]

The polymer (A) is a polymer from which the hydrogen abstraction type photoinitiator (B) is capable of abstracting a hydrogen. One type of component (A) may be used alone, or two or more types of components (A) may be used in combination.

The component (A) is a polymer from which the hydrogen abstraction type photoinitiator (B) is capable of abstracting a hydrogen and is not particularly limited as long as the effects of the present invention are exerted. However, the component (A) is preferably, for example, at least one selected from the group consisting of a polyvinyl chloride-based resin, polyolefin, an acrylic resin, and a styrene-based resin.

On the other hand, examples of polymers from which the component (B) is not capable of abstracting any hydrogen, that is, polymers which are not the component (A) include polyethylene terephthalate.

Examples of the polyolefin include homopolymers or copolymers of linear, branched, or cyclic olefin monomers. Examples of the linear, branched, or cyclic olefin monomers include ethylene; α-olefins such as propylene, 1-butene, 4-methyl-1-pentene, 1-pentene, 1-hexene, and 1-octene; and cycloolefin. Examples of the homopolymers or copolymers thereof include polypropylene and polyethylene. In addition, examples of the polyolefin include copolymers containing an olefin-based monomer as the main monomer, such as an ethylene-vinyl acetate copolymer (EVA), an ethylene-(meth)acrylic acid copolymer, and an ethylene-(meth)acrylate copolymer. Herein, the “main monomer” refers to a monomer with the largest content among all the monomer components of the resulting polymer.

Examples of the acrylic resin include homopolymers or copolymers of acrylic monomers such as ethylenically unsaturated carboxylic acid such as (meth)acrylic acid; and alkyl (meth)acrylates such as methyl (meth)acrylate, and examples of the homopolymers or copolymers include polymethyl methacrylate (PMMA). In addition, examples of the acrylic resin include copolymers containing an acrylic monomer as the main monomer such as an ethylene-(meth)acrylic acid copolymer and an ethylene-(meth)acrylate copolymer.

Examples of the styrene-based resin include polystyrene.

The component (A) more preferably contains at least a polyvinyl chloride-based resin, and even more preferably is a polyvinyl chloride-based resin.

The polyvinyl chloride-based resin is a polymer having a repeating unit derived from vinyl chloride.

The polyvinyl chloride-based resin may be a homopolymer of vinyl chloride (polyvinyl chloride) or may be a copolymer of vinyl chloride and a monomer that is copolymerizable with the vinyl chloride. In an aspect of the present invention, the vinyl chloride-based resin is preferably polyvinyl chloride.

Examples of the copolymer of the polyvinyl chloride-based resin include copolymers mainly containing vinyl chloride, such as an ethylene-vinyl chloride copolymer, a vinyl acetate-vinyl chloride copolymer, and a vinyl chloride-halogenated olefin copolymer.

In the copolymer mainly made of vinyl chloride, the amount of the repeating unit derived from vinyl chloride is preferably 50 mol % or more, more preferably 60 mol % or more, and even more preferably 70 mol % or more in all the repeating units.

The average degree of polymerization of the polyvinyl chloride-based resin is not particularly limited as long as the effects of the present invention are exerted. However, the degree is preferably from 500 to 5000, more preferably from 800 to 2500, and even more preferably from 1000 to 2000.

In addition, one type of the polyvinyl chloride-based resin may be used alone, or two or more types of the polyvinyl chloride-based resins may be used in combination. Furthermore, the polyvinyl chloride-based resin may be used in combination with another resin. As another resin, a resin having excellent compatibility with the polyvinyl chloride-based resin is preferred.

When the polyvinyl chloride-based resin is used in combination with another resin, the blending amount of the other resin is preferably from 1 to 50 parts by mass, more preferably from 3 to 30 parts by mass, and even more preferably from 5 to 10 parts by mass with respect to 100 parts by mass of the polyvinyl chloride-based resin.

In addition, as will be described later, when the polyvinyl chloride-based resin is used, it is preferable to use a plasticizer from the viewpoint of improving the flexibility of the substrate.

How much the component (A) is contained in the resin film is not particularly limited as long as the effects of the present invention are exerted. However, the component (A) contained in the resin film accounts for, for example, preferably 50 mass % or more, more preferably 60 mass % or more, and even more preferably 70 mass % or more, and preferably 99 mass % or less, more preferably 95 mass % or less, and even more preferably 90 mass % or less with respect to 100 mass % of the total of the components of the resin film.

In an aspect of the present invention, when the resin film uses the polyvinyl chloride-based resin as the component (A), how much the component (A) is contained in the resin film is not particularly limited as long as the effects of the present invention are exerted. However, the component (A) contained in the resin film accounts for, for example, preferably 50 mass % or more, more preferably 60 mass % or more, and even more preferably 70 mass % or more, and preferably 90 mass % or less, more preferably 85 mass % or less, and even more preferably 80 mass % or less with respect to 100 mass % of the total of the components of the resin film.

### [Hydrogen Abstraction Type Photoinitiator (B)]

The hydrogen abstraction type photoinitiator (B) has a function of generating a radical by reacting with a hydrogen donor upon irradiation with an energy ray. Then, the component (B) abstracts hydrogen bonded to carbon in the main chain skeleton or the like in the component (A) to generate a radical serving as a reaction initiation point in the component (A), and a crosslinking reaction occurs between the components (A) and between the component (A) and the polymer component in the pressure sensitive adhesive composition layer. It is considered that the direct crosslinking reaction between the component (A) and the polymer component in the pressure sensitive adhesive composition layer improves the adhesion at the interface between the substrate and the pressure sensitive adhesive layer in the second pressure sensitive adhesive sheet formed by irradiation with an energy ray. As a result, the second pressure sensitive adhesive sheet becomes a pressure sensitive adhesive sheet which is excellent in substrate adhesion and can be detached without fouling of an adherend.

Examples of the component (B) include aromatic ketones such as acetophenone, benzophenone, P,P′-dimethoxybenzophenone, 4-methylbenzophenone, P,P′-dichlorobenzophenone, P,P′-dimethylbenzophenone, and acetonaphthone. Other examples include aromatic aldehyde such as terephthalaldehyde, and quinone-based aromatic compounds such as methylanthraquinone. Among them, a compound containing benzophenone is preferably used from the viewpoint of ease of radical generation.

One type of component (B) may be used alone, or two or more types of components (B) may be used in combination.

How much the component (B) is contained in the resin film is not particularly limited as long as the effects of the present invention are exerted. However, the component (B) contained in the resin film accounts for, for example, preferably 0.1 parts by mass or more, more preferably 0.3 parts by mass or more, and even more preferably 0.5 parts by mass or more with respect to 100 parts by mass of the component (A) of the resin film from the viewpoint of providing a pressure sensitive adhesive sheet capable of being detached without fouling of an adherend, and is preferably 10 parts by mass or less, more preferably 9 parts by mass or less, and even more preferably 8 parts by mass or less from the viewpoint of flexibility of the substrate.

### [Additional Component]

The resin film may contain an additional component besides the component (A) and the component (B), if necessary, as long as the effects of the present invention are exerted.

Examples of the additional component include an additive for the substrate and the like, such as a plasticizer, a known filler, an ultraviolet absorber, a light stabilizer, an antioxidant, an antistatic agent, a slip agent, an antiblocking agent, a colorant, and a catalyst. Note that for each of these additives for the substrate, one type thereof may be used alone, or two or more types thereof may be used in combination.

### {Plasticizer}

In an aspect of the present invention, when the resin film contains a polyvinyl chloride-based resin as the component (A), the resin film preferably further contains a plasticizer as the additional component from the viewpoint of improving the flexibility of the substrate.

Any plasticizer can be used without particular limitation as long as the plasticizer is compatible with the polyvinyl chloride-based resin. Examples of the plasticizer include a phthalic acid-based plasticizer such as dibutyl phthalate (DBP), dioctyl phthalate (DOP), diisononyl phthalate (DINP), diisodecyl phthalate (DIDP), and diundecyl phthalate (DUP); an adipic acid-based plasticizer such as dibutyl adipate; a phosphoric acid-based plasticizer such as tributyl phosphate, tricresyl phosphate, and triphenyl phosphate; a trimellitic acid-based plasticizer such as tributyl trimellitate and trioctyl trimellitate; various polyester-based plasticizers such as an adipic acid-based polyester; and a citrate such as acetyl tributyl citrate and acetyl trioctyl citrate.

One type of these plasticizers may be used alone, or two or more types of these plasticizers may be used in combination.

When the resin film contains the polyvinyl chloride-based resin as the component (A) and further contains the plasticizer, how much the plasticizer is contained is not particularly limited as long as the effects of the present invention are exerted. However, the plasticizer accounts for, for example, preferably 15 parts by mass or more, more preferably 20 parts by mass or more, and even more preferably 25 parts by mass or more, and preferably 50 parts by mass or less, more preferably 40 parts by mass or less, and even more preferably 35 parts by mass or less, with respect to 100 parts by mass of the polyvinyl chloride-based resin of the resin film.

From the viewpoint that the effects of the present invention are more easily exerted, the total content of the component (A) and the component (B) in the resin film is preferably from 60 to 100 mass %, more preferably from 65 to 100 mass %, even more preferably from 70 to 100 mass %, and still more preferably from 75 to 100 mass % with respect to 100 mass % of the total amount of the components of the resin film.

In an aspect of the present invention, when the resin film contains the polyvinyl chloride-based resin as the component (A) and further contains the plasticizer, the total content of the component (A) and the component (B) in the resin film is preferably 60 mass % or more, more preferably 65 mass % or more, even more preferably 70 mass % or more, and preferably 90 mass % or less, more preferably 85 mass % or less, even more preferably 80 mass % or less with respect to 100 mass % of the total amount of the components of the resin film.

In an aspect of the present invention, when the resin film contains the polyvinyl chloride-based resin as the component (A) and further contains the plasticizer, the total content of the component (A), the component (B), and the plasticizer in the resin film is preferably from 60 to 100 mass %, more preferably from 70 to 100 mass %, and even more preferably from 80 to 100 mass % per 100 mass % of the total amount of the components of the resin film.

A support may be further laminated on a surface of the resin film, the surface being on the opposite side to the surface in contact with the pressure sensitive adhesive composition layer.

However, when the first pressure sensitive adhesive sheet has a laminate of the resin film and the support, at least one pressure sensitive adhesive composition layer is laminated on a surface of at least one resin film.

Further, for example, the resin film may be used as the support.

For example, as an aspect of the pressure sensitive adhesive sheet, the pressure sensitive adhesive composition layer may be laminated on one surface or both surfaces of a laminate in which two layers of the resin film are laminated.

In addition, for example, one aspect of the pressure sensitive adhesive sheet may be an aspect in which the pressure sensitive adhesive composition layer is laminated on one surface or both surfaces of a laminate made of a two or more layer structure having, on one surface of the resin film, the resin film and one or more supports selected from a support other than the resin film. However, at least one pressure sensitive adhesive composition layer is laminated on a surface of at least one resin film.

Moreover, for example, one aspect of the pressure sensitive adhesive sheet may be an aspect in which the pressure sensitive adhesive composition layer is laminated on one surface or both surfaces of a laminate having the resin films on both surfaces thereof and made of a three or more layer structure having, between the two resin films present on both surfaces, one or more supports selected from the resin film and a support other than the resin film. However, at least one pressure sensitive adhesive composition layer is laminated on a surface of at least one resin film.

When a plurality of resin films is present in each of the laminates, the plurality of resin films may be the same or different. That is, the components of the plurality of resin films may be the same or different.

Furthermore, for example, when the pressure sensitive adhesive composition layer is laminated on one surface of the monolayer resin film as an aspect of the pressure sensitive adhesive sheet, the pressure sensitive adhesive sheet may be a double-sided pressure sensitive adhesive sheet in which a pressure sensitive adhesive composition layer other than the pressure sensitive adhesive composition layer or a pressure sensitive adhesive layer other than a pressure sensitive adhesive layer formed from the pressure sensitive adhesive composition layer is laminated on a the surface opposite to the surface on which the pressure sensitive adhesive composition layer is laminated.

Similarly, for example, as an aspect of the pressure sensitive adhesive sheet, in the laminate in which the pressure sensitive adhesive composition layer is laminated on one surface of each laminate, the pressure sensitive adhesive sheet may be a double-sided pressure sensitive adhesive sheet in which a pressure sensitive adhesive composition layer other than the pressure sensitive adhesive composition layer or a pressure sensitive adhesive layer other than a pressure sensitive adhesive layer formed from the pressure sensitive adhesive composition layer is laminated on the surface opposite to the surface on which the pressure sensitive adhesive composition layer is laminated.

Examples of a material forming the support include a resin, a metal, and a paper material.

Examples of the resin used for the support include a vinyl-based resin such as polyvinylidene chloride, polyvinyl alcohol, an ethylene-vinyl acetate copolymer, and an ethylene-vinyl alcohol copolymer; a polyester-based resin such as polyethylene terephthalate, polybutylene terephthalate, and polyethylene naphthalate; polystyrene; an acrylonitrile-butadiene-styrene copolymer; cellulose triacetate; polycarbonate; a urethane resin such as polyurethane and acrylic-modified polyurethane; polysulfone; polyether ether ketone; polyethersulfone; polyphenylene sulfide; a polyimide-based resin such as polyetherimide and polyimide; a polyamide-based resin; and a fluorine-based resin.

Note that, as previously mentioned, when a resin is used as a material for forming the support, the aforementioned component (A) may be used.

Examples of the metal include aluminum, tin, chromium, and titanium.

Examples of the paper material include tissue paper, wood containing paper, wood-free paper, impregnated paper, coat paper, art paper, vegetable parchment, and glassine paper.

One type of the material for forming the support may be used alone, or two or more types of the material may be used in combination.

Moreover, if necessary, the support may contain one or more types of the additives for the substrate previously described in the section of the resin film.

Examples of the support in which two or more type of the material for forming the support are used in combination include a support in which a paper material is laminated with a thermoplastic resin such as polyethylene, and a support in which a metal film is formed on a surface of a resin film containing a resin. Note that examples of a method for forming a metal layer include a method of subjecting the metal to vapor deposition by a PVD method, such as vacuum deposition, sputtering, or ion plating; or a method of attaching a metal foil made of the metal using a widely-used pressure sensitive adhesive.

Note that, from the viewpoint of improving interlayer adhesion of the support and another layer to be laminated, in a case where the support contains a resin, surface treatment by an oxidation method, a roughening method, or the like, or primer treatment may be performed to a surface of the support.

Moreover, depending on the application of the pressure sensitive adhesive sheet, the support may have, for example, an easy adhesion layer for facilitating printing; a recording layer for enabling recording, such as thermal transfer recording and ink-jet recording; an overcoat film or an overlaminate film for protecting these surfaces; and/or an information region, such as a magnetic recording, a bar code, or a micro semiconductor device.

The thickness of the resin film is not particularly limited, but is preferably from 5 to 1000 μm, more preferably from 15 to 500 μm, and even more preferably from 20 to 200 μm.

Furthermore, when the laminate of the resin film and the support (including a laminate made of only a plurality of resin films as previously mentioned) is used, the thickness of the laminate is also not particularly limited. However, the thickness is preferably from 5 to 2000 μm, more preferably from 15 to 500 μm, and even more preferably from 20 to 200 μm.

### (Method for Producing Resin Film)

The method for producing the resin film is not particularly limited as long as the resin film containing the component (A) and the component (B) can be produced, and the resin film can be produced by a known method such as a casting method, a calendar method, or an extrusion molding method.

An aspect of the method for producing the resin film includes, for example, a production method including an applying step of applying a resin film forming composition containing the component (A), the component (B), and the additional component contained as necessary, on the support or the release liner.

Note that, in the present specification, “on the release liner” means “on the release-treated surface” for a release liner subjected to single-sided release treatment.

The release liner that can be used in the method for producing the resin film is not particularly limited, and a release liner similar to the release liner that can be used in the pressure sensitive adhesive sheet according to an aspect of the present invention described later can be used.

In an aspect of the method for producing the resin film, for example, the resin film may be produced through a step of dissolving or dispersing the component (A), the component (B), and an optional component contained as necessary, in an organic solvent for dilution and mixing them to form a liquid matter such as a solution or a sol of the resin film forming composition.

The organic solvent is not particularly limited as long as the organic solvent can dissolve or disperse the component (A), the component (B), and the additional component contained as necessary to be mixed, and can form a coating film in the applying step.

Examples of the organic solvent include methyl ethyl ketone, methyl isobutyl ketone, acetone, ethyl acetate, tetrahydrofuran, dioxane, cyclohexane, n-hexane, toluene, xylene, n-propanol, isopropanol, ethylene glycol monobutyl ether, a paraffinic hydrocarbon, and a naphthenic hydrocarbon.

When the liquid of the resin film forming composition is used, the organic solvent contained in the liquid of the resin film forming composition accounts for preferably from 10 to 90 mass %, more preferably from 15 to 85 mass %, and even more preferably from 20 to 80 mass %.

In the step, without using an organic solvent for dilution, for example, the aforementioned plasticizer may be mixed with the component (A), the component (B), and the additional component contained as necessary to produce a liquid of the resin film forming composition in a paste form.

Then, the liquid of the resin film forming composition produced through the above-described steps is formed into the resin film by using, for example, a casting method.

For example, the resin film may be formed by applying the liquid of the resin film forming composition onto the support or the release liner to form a coating film, and then subjecting the coating film to either or both drying treatment and heating treatment.

Examples of the method for applying the liquid of the resin film forming composition onto the support or the release liner include a bar coating method, a knife coating method, a roll coating method, a blade coating method, a die coating method, and a gravure coating method.

Moreover, the method and temperature for either or both the drying treatment and the heating treatment of the coating film made of the resin film forming composition are not particularly limited, and may be selected as appropriate depending on the properties of the material forming the resin film forming composition and the like.

Therefore, the temperature of each treatment is not particularly limited as long as the resin film is formed. However, the temperature is, for example, preferably lower than the boiling points of the component (A) and the component (B), and more preferably lower than the boiling points of the component (A), the component (B), and the additional component contained as necessary in an aspect of the method for producing the resin film.

In an aspect of the method for producing the resin film, for example, the resin film forming composition may be produced through a melt-kneading step of melt-kneading the component (A), the component (B), and an optional component contained as necessary.

The melt-kneading step is, for example, a step of charging each component into a mixing device equipped with a heating device, such as a heating kneader, and mixing the components in a melted state.

Examples of the mixing device equipped with a heating device include a single-screw extruder, a twin-screw extruder, a rolling mill, a Banbury mixer, an intermix, and a pressure kneader.

In a case where a mixing device that can reduce pressure is used, as necessary, the pressure in the inside of the mixing device may be reduced, and the melt-kneading may be performed under reduced pressure.

The temperature at the time of melt-kneading is preferably lower than the boiling points of the component (A) and the component (B), and more preferably lower than the boiling points of the component (A), the component (B), and the additional component contained as necessary.

When the resin film is produced through the melt-kneading step, the resin film may be formed by applying the resin film forming composition produced in the melt-kneading step onto the support or the release liner using an extruder, a T-die, or the like in a heat-melted state. Alternatively, the resin film forming composition obtained in the melt-kneading step may be cooled once to be formed into a pellet form, a powder form, or the like, and then heated and melted again to be applied. Moreover, without using the support or the release liner, the resin film may be formed from the resin film forming composition produced in the melt-kneading step or the melted matter produced by reheating and melting using a calendar, a T-die, or the like.

Thereafter, as necessary, a step of cooling the resin film may be included.

### <Pressure Sensitive Adhesive Layer>

The pressure sensitive adhesive layer is formable by irradiating an energy ray-crosslinkable pressure sensitive adhesive composition layer made of an energy ray-crosslinkable pressure sensitive adhesive composition with an energy ray. That is, as previously mentioned, the pressure sensitive adhesive composition layer is formable by irradiating the pressure sensitive adhesive composition layer of the first pressure sensitive adhesive sheet with an energy ray.

### (Energy Ray-Crosslinkable Pressure Sensitive Adhesive Composition Layer)

The energy ray-crosslinkable pressure sensitive adhesive composition layer of the first pressure sensitive adhesive sheet is made of an energy ray-crosslinkable pressure sensitive adhesive composition. The energy ray-crosslinkable pressure sensitive adhesive composition layer is irradiated with an energy ray to form a pressure sensitive adhesive layer of the second pressure sensitive adhesive sheet.

The energy ray-crosslinkable pressure sensitive adhesive composition forms a crosslinked pressure sensitive adhesive due to formation of a crosslinked structure caused by irradiation with an energy ray. That is, the pressure sensitive adhesive composition is a composition that is designed to be irradiated with an energy ray before or after attaching to an adherend.

The pressure sensitive adhesive composition can be irradiated with the energy ray at freely chosen time. Thus, the pressure sensitive adhesive composition has high degree of freedom in the production method and using method thereof.

The pressure sensitive adhesive composition is a pressure sensitive adhesive composition having energy ray-crosslinkability and is not particularly limited as long as the effects of the present invention are exerted.

The energy ray-crosslinkable pressure sensitive adhesive composition is preferably a pressure sensitive adhesive composition (I) containing an acrylic polymer (C) having energy ray-crosslinkability, or a pressure sensitive adhesive composition (II) containing an acrylic polymer (D) other than the component (C) and a hydrogen abstraction type photoinitiator (B).

### Pressure Sensitive Adhesive Composition (I)

The pressure sensitive adhesive composition (I) contains an acrylic polymer (C) having energy ray-crosslinkability (hereinafter, also referred to as a “component (C)”).

### {Acrylic Resin Having Energy Ray-Crosslinkability}

The component (C) is not particularly limited as long as the component (C) is an acrylic polymer having energy ray-crosslinkability.

In the pressure sensitive adhesive composition, one type of component (C) may be used alone, or two or more types of the components (c) may be used in combination.

Examples of the component (C) include an acrylic polymer (C1) having an energy ray-reactive group that reacts by energy ray irradiation and contributes to formation of a crosslinked structure (hereinafter, also referred to as a “component (C1)”) and an acrylic polymer (C2) having no energy ray-reactive group but having an energy ray-polymerizable group (hereinafter, also referred to as a “component (C2)”), and the component (C1) is preferred.

### {{(C1) Acrylic Polymer Having Energy Ray-Reactive Group}}

Examples of the energy ray-reactive group of the component (C1) include a group that is excited by irradiation with an energy ray and generates a radical which triggers a crosslinking reaction.

Specific examples of the energy-ray-reactive group include functional groups having a structure, such as a benzophenone structure, a benzyl structure, an o-benzoylbenzoate structure, a thioxanthone structure, a 3-ketocoumarin structure, a 2-ethylanthraquinone structure, and a camphorquinone structure. Among these, the component (C1) preferably has a benzophenone structure in a side chain.

When the component (C1) has a benzophenone structure, for example, the benzophenone structure abstracts a hydrogen atom from a hydrocarbon group contained in a side chain of the acrylic polymer by energy ray irradiation, and the radicals are recombined to form crosslinked structure.

Note that the energy ray-reactive group is preferably introduced into a side chain of the acrylic polymer from the viewpoint of facilitating the formation of the crosslinked structure. That is, the component (C1) is preferably an acrylic polymer having a benzophenone structure in a side chain.

The energy ray-reactive group contained in the component (C1) accounts for preferably from 0.02 to 5.0 mass % and more preferably from 0.05 to 3.0 mass % with respect to the total amount (100 mass %) of the component (C).

As a method of introducing the energy ray-reactive group into the component (C1), for example, a monomer having a functional group such as a vinyl group capable of reacting with an acrylic monomer and having the energy ray-reactive group may be copolymerized with the acrylic monomer to introduce the energy ray-reactive group. Alternatively, for example, the energy ray-reactive group may be introduced by reacting a compound having the energy ray-reactive group with a side chain of the acrylic polymer by a known method.

The component (C1) is a polymer containing an acrylic monomer as a monomer component and is not particularly limited as long as the component (C1) has an energy ray-reactive group, but preferably contains a constituent unit derived from an alkyl (meth)acrylate.

Examples of the alkyl (meth)acrylate include methyl (meth)acrylate, ethyl (meth)acrylate, n-propyl (meth)acrylate, n-butyl (meth)acrylate, isobutyl (meth)acrylate, sec-butyl (meth)acrylate, tert-butyl (meth)acrylate, n-pentyl (meth)acrylate, n-hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, n-dodecyl (meth)acrylate, n-tridecyl (meth)acrylate, myristyl (meth)acrylate, palmityl (meth)acrylate, and stearyl (meth)acrylate. Among these, the alkyl (meth)acrylate is preferably an alkyl (meth)acrylate in which the alkyl group has from one to eight carbons, and is more preferably 2-ethylhexyl (meth)acrylate, methyl (meth)acrylate, or butyl (meth)acrylate.

Moreover, one type of these alkyl (meth)acrylates may be used alone, or two or more types of these alkyl (meth)acrylates may be used in combination.

The constituent unit derived from alkyl (meth)acrylate in the component (C1) accounts for preferably from 80 to 100 mass %, more preferably from 90 to 100 mass %, even more preferably from 95 to 100 mass %, and still more preferably from 98 to 100 mass % with respect to the total of the constituent units (100 mass %) of the component (C1).

In the present specification, how much the monomer constituent unit is contained with respect to the total of the constituent units (100 mass %) of the component (C1) can also be regarded as how much the monomer is contained with respect to 100 mass % of the total amount of the monomers blended when the component (C1) is synthesized.

Furthermore, unless otherwise stated, the total of the constituent units (100 mass %) of the component (C1) does not include, for example, a constituent unit derived from a polymerization initiator, a chain transfer agent, and a compound having an energy ray-reactive group used in polymerization of the polymer.

In addition, as the constituent unit derived from the monomer of the acrylic polymer, a constituent unit derived from other monomers other than the alkyl (meth)acrylate may be included as necessary. Examples of other monomers other than the alkyl (meth)acrylate that can be used in the component (C1) include a monomer (c22) and a monomer (c23) described later.

The weight average molecular weight (Mw) of the component (C1) is not particularly limited as long as the effects of the present invention are exerted. However, the weight average molecular weight (Mw) is, for example, preferably from 10000 to 2000000, more preferably from 50000 to 1500000, and even more preferably from 100000 to 1000000.

Moreover, when the pressure sensitive adhesive composition (I) is used as a hot melt pressure sensitive adhesive in an aspect of the present invention, the weight average molecular weight (Mw) of the component (C1) is preferably from 10000 to 500000, more preferably from 50000 to 400000, and even more preferably from 100000 to 300000.

When the pressure sensitive adhesive composition (I) contains the component (C1) as the component (C), the component (C1) contained in the pressure sensitive adhesive composition (I) accounts for preferably from 50 to 100 mass %, more preferably from 70 to 100 mass %, even more preferably from 80 to 100 mass %, and still more preferably from 90 to 100 mass %, or may be 100 mass %, with respect to 100 mass % of the total amount of the pressure sensitive adhesive composition (I).

Note that, when the pressure sensitive adhesive composition (I) is diluted with an organic solvent, water, or the like as described later, the “total amount of the pressure sensitive adhesive composition” means the total amount of the solids content excluding the diluting solvent. The same applies to the pressure sensitive adhesive composition (II) described later.

### {{(C2) Acrylic Polymer Having No Energy Ray-Reactive Group and Having Energy Ray-Polymerizable Group}}

Examples of the component (C2) include an acrylic polymer having no aforementioned energy ray-reactive group, having an energy ray-polymerizable group introduced therein, and having a constituent unit derived from (meth)acrylate. The energy ray-polymerizable group is preferably introduced into a side chain of the acrylic polymer.

Unlike the aforementioned energy ray-reactive group, the energy ray-polymerizable group itself is not excited by irradiation with an energy ray to generate a radical which triggers a crosslinking reaction, but may be a group which is polymerizable by a radical generated by a radical polymerization initiator or the like. For example, the energy ray-polymerizable group is only required to be a group containing an energy ray polymerizable carbon-carbon double bond. Examples thereof include a (meth)acryloyl group and a vinyl group, and among them, a (meth)acryloyl group is preferred.

The component (C2) preferably contains an acrylic copolymer (C2az) (hereinafter, also referred to as a “component (C2az)”) which is a reactant produced by reacting a polymerizable compound (Zc) having an energy ray-polymerizable group with an acrylic copolymer (C2a) (hereinafter, also referred to as a “component (C2a)”) having a constituent unit derived from alkyl (meth)acrylate (C21) and a constituent unit derived from a functional group-containing monomer (C22).

Note that the form of the copolymerization of the component (C2a) is not particularly limited, and may be any of block copolymers, random copolymers, and the like. The component (C2az) accounts for preferably from 70 to 100 mass %, more preferably from 80 to 100 mass %, and even more preferably from 90 to 100 mass % with respect to the total amount (100 mass %) of the component (C2) contained in the pressure sensitive adhesive composition.

Examples of the alkyl (meth)acrylate (c21) (hereinafter, also referred to as a “monomer (c21)”) preferably include alkyl (meth)acrylate having an alkyl group with from 1 to 18 carbons. Specific examples thereof include the same alkyl (meth)acrylates exemplified as the monomer components of the components (C1).

One type of the monomer (c21) may be used alone, or two or more types of the monomers (c21) may be used in combination.

Among the monomers (c21) described above, alkyl (meth)acrylate having an alkyl group with from one to eight carbons is more preferred.

How much the constituent unit derived from the monomer (C21) is contained in the component (C2a) is not particularly limited as long as the effects of the present invention are exerted. However, the constituent unit derived from the monomer (C21) accounts for, for example, preferably from 50 to 99 mass %, more preferably from 60 to 98 mass %, and even more preferably from 70 to 97 mass % with respect to the total of the constituent units (100 mass %) of the component (C2a).

The functional group-containing monomer (c22) (hereinafter, also referred to as a “monomer (c22)”) is a monomer having a functional group such as a hydroxy group, a carboxy group, an epoxy group, an amino group, a cyano group, a nitrogen-containing cyclic group, or an alkoxysilyl group. Among the monomers (c22) described, one or more selected from a hydroxy group-containing monomer, a carboxy group-containing monomer, and an epoxy group-containing monomer is preferred.

One type of the monomer (c22) may be used alone, or two or more types of the monomers (c22) may be used in combination.

Examples of the hydroxyl group-containing monomer include hydroxyalkyl (meth)acrylates, such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate; and unsaturated alcohols, such as vinyl alcohol and allyl alcohol.

Examples of the carboxy group-containing monomer include ethylenically unsaturated carboxylic acids, such as (meth)acrylic acid, crotonic acid, maleic acid, fumaric acid, itaconic acid, and citraconic acid.

Examples of the epoxy group-containing monomer include an epoxy group-containing (meth)acrylate and a non-acrylic epoxy group-containing monomer. Examples of the epoxy group-containing (meth)acrylate include glycidyl (meth)acrylate, β-methylglycidyl (meth)acrylate, (3,4-epoxycyclohexyl) methyl (meth)acrylate, and 3-epoxycyclo-2-hydroxypropyl (meth)acrylate. Moreover, examples of the non-acrylic epoxy group-containing monomer include glycidyl crotonate and allyl glycidyl ether.

In addition, as the monomer (c22), a hydroxy group-containing monomer is preferred. Specifically, various hydroxyalkyl (meth)acrylates such as 2-hydroxyethyl (meth)acrylate are more preferred, and 2-hydroxyethyl (meth)acrylate is more preferred. By using hydroxyalkyl (meth)acrylate, the polymerizable compound (Zc) can be relatively easily reacted with the component (C2a).

How much the constituent unit derived from the monomer (c22) is contained in the component (C2a) is not particularly limited as long as the effects of the present invention are exerted. However, the constituent unit derived from the monomer (c22) accounts for, for example, preferably from 1 to 20 mass %, more preferably from 2 to 15 mass %, and even more preferably from 3 to 10 mass % with respect to the total of the constituent units (100 mass %) of the component (C2a).

When the constituent unit derived from the monomer (c22) accounts for 1 mass % or more, a certain amount of a functional group serving as a reaction point with the polymerizable compound (Zc) can be secured. Therefore, the pressure sensitive adhesive layer can be appropriately crosslinked by irradiation with an energy ray. In addition, when the constituent unit derived from the monomer (c22) accounts for 20 mass % or less, a sufficient adhesive force can be provided.

The component (C2a) may be a copolymer made only of a constituent unit derived from the monomer (c21) and a constituent unit derived from the monomer (c22) (excluding a constituent unit derived from a component other than the monomers, such as a polymerization initiator and a chain transfer agent), or may be a copolymer containing a constituent unit derived from another monomer (c23) other than the monomers (c22) and (c21) (hereinafter, also referred to as a “monomer (c23)”) in addition to the constituent unit derived from the monomer (c22) and the constituent unit derived from the monomer (c23).

Examples of the monomer (c23) include a (meth)acrylate having a cyclic structure, such as cyclohexyl (meth)acrylate, benzyl (meth)acrylate, isobornyl (meth)acrylate, dicyclopentanyl (meth)acrylate, dicyclopentenyl (meth)acrylate, and dicyclopentenyloxyethyl (meth)acrylate, vinyl acetate, and styrene.

One type of the monomer (c23) may be used alone, or two or more types of the monomers (c23) may be used in combination.

When the component (C2a) contains a constituent unit derived from the monomer (c23), how much the constituent unit derived from the monomer (C23) is contained in the component (C2a) is not particularly limited as long as the effects of the present invention are exerted. For example, the constituent unit derived from the monomer (C23) accounts for preferably from 1 to 30 mass %, more preferably from 1 to 20 mass %, and even more preferably from 1 to 10 mass % with respect to the total of the constituent units (100 mass %) of the component (C2a).

The polymerizable compound (Zc) is a compound having an energy ray-polymerizable group and a substituent (hereinafter, also referred to as a “reactive substituent”) capable of reacting with a functional group in the constituent unit derived from the monomer (c22) of the component (C2a).

Examples of the energy ray-polymerizable group include a (meth)acryloyl group and a vinyl group, and a (meth)acryloyl group is preferred. Moreover, the polymerizable compound (Zc) is preferably a compound having one to five energy ray-polymerizable groups per molecule.

The reactive substituent in the polymerizable compound (Zc) may be changed as appropriate depending on the functional group of the monomer (c22), and examples thereof include an isocyanate group, a carboxyl group, and an epoxy group. From the viewpoint of reactivity and the like, the isocyanate group is preferred. When the polymerizable compound (Zc) has the isocyanate group, for example, the polymerizable compound (Zc) can easily react with the component (C2a) in a case where the functional group of the monomer (c22) is a hydroxy group.

Specific examples of the polymerizable compound (Zc) include 2-(meth)acryloyloxyethyl isocyanate, meta-isopropenyl-α,α-dimethylbenzyl isocyanate, (meth)acryloyl isocyanate, allyl isocyanate, glycidyl (meth)acrylate, and (meth)acrylic acid. One type of these polymerizable compounds (Zc) may be used alone, or two or more types of these polemrizable compounds (Zc) may be used in combination.

Among these, 2-(meth)acryloyloxyethyl isocyanate is preferred, and 2-methacryloyloxyethyl isocyanate is more preferred, from the viewpoint that the compound has a suitable isocyanate group as the reactive substituent and the distance between the main chain and the energy ray-polymerizable group is appropriate.

The component (C2az) is produced by reacting the polymerizable compound (Zc) with preferably from 40 to 98 molar equivalents, more preferably from 50 to 95 molar equivalents, and even more preferably from 60 to 90 molar equivalents of the total amount (100 molar equivalents) of the functional group derived from the monomer (c22) in the component (C2a).

The weight average molecular weight (Mw) of the component (C2) is not particularly limited as long as the effects of the present invention are exerted. However, the weight average molecular weight (Mw) is, for example, preferably from 100000 to 1500000, more preferably from 250000 to 1000000, and even more preferably from 300000 to 900000.

When the pressure sensitive adhesive composition (I) contains the component (C2) as the component (C), how much the component (C2) is contained in the pressure sensitive adhesive composition (I) is not particularly limited as long as the effects of the present invention are exerted. For example, the component (C2) accounts for preferably from 55 to 99 mass %, more preferably from 65 to 98 mass %, and even more preferably from 75 to 96 mass % with respect to 100 mass % of the total amount of the pressure sensitive adhesive composition (I).

### Photopolymerization Initiator

When the pressure sensitive adhesive composition (I) contains the component (C2) as the component (C), the pressure sensitive adhesive composition (I) preferably further contains a photopolymerization initiator. When the pressure sensitive adhesive composition (I) contains the component (C2) as the component (C), the photopolymerization initiator contained therein facilitates the progress of energy ray-crosslinking of the pressure sensitive adhesive composition by ultraviolet rays or the like.

Examples of the photopolymerization initiator include benzoin compounds, acetophenone compounds, acylphosphinoxide compounds, titanocene compounds, thioxanthone compounds, azo-based compounds, peroxide compounds, and photosensitizers such as amines and quinones.

One type of the photopolymerization initiators may be used alone, or two or more types of these photopolymerization initiators may be used in combination.

The photopolymerization initiator accounts for preferably from 0.3 to 15 parts by mass and more preferably from 1 to 10 parts by mass with respect to 100 parts by mass of the component (C2).

Moreover, the pressure sensitive adhesive composition (I) may further contain a polymer other than the component (C) in addition to the component (C). The polymer other than the component (C) is not particularly limited as long as the effects of the present invention are exerted. Examples thereof include an acrylic polymer (D) other than the component (C) (hereinafter, also referred to as a “component (D)”) described later, and an energy ray-curable pressure sensitive adhesive resin (E) other than the component (C) having an energy ray-polymerizable functional group introduced into a side chain (hereinafter, also referred to as a “component (E)”).

In addition, the component (B) and one or more selected from other components described later may be contained as necessary.

However, in a case of a composition containing the component (D) and the component (B) as the polymer other than the component (C), a pressure sensitive adhesive composition containing the component (C) more than the component (D) is regarded as the pressure sensitive adhesive composition (I), while a pressure sensitive adhesive composition containing the component (D) more than the component (C) is regarded as the following pressure sensitive adhesive composition (II).

### [Pressure Sensitive Adhesive Composition (II)]

The pressure sensitive adhesive composition (II) contains an acrylic polymer (D) other than the component (C), and a hydrogen abstraction type photoinitiator (B). {Acrylic Polymer Other Than Component (C)}

The component (D) is not particularly limited as long as the component (D) is an acrylic polymer other than the component (C) and the effects of the present invention are exerted. One type of component (D) may be used alone, or two or more types of components (D) may be used in combination.

The component (D) is not particularly limited as long as the component (D) is a polymer containing an acrylic monomer as a monomer component, but the component (D) preferably contains a constituent unit derived from alkyl (meth)acrylate (d1). As alkyl (meth)acrylate (d1) (hereinafter, also referred to as a “monomer (d1)”) that can be used in the component (D), for example, alkyl (meth)acrylate having an alkyl group with from 1 to 18 carbons is suitably used. Specific examples thereof include the same alkyl (meth)acrylates exemplified as the monomer components of the components (C1).

One type of the monomers (d1) may be used alone, or two or more types of the monomers (d1) may be used in combination.

Among the monomers (d1) described above, alkyl (meth)acrylate having an alkyl group with from 1 to 8 carbons is more preferred.

How much the constituent unit derived from the monomer (d1) is contained in the component (D) is preferably from 60 to 100 mass %, more preferably from 70 to 100 mass %, even more preferably from 80 to 100 mass %, and still more preferably from 85 to 100 mass % with respect to the total of the constituent units (100 mass %) of the component (D).

Moreover, when the component (D) also contains one or more types of constituent units selected from the following monomers (d2) and (d3) as an aspect, how much the constituent unit derived from the monomer (d1) is contained in the component (D) is preferably from 60 to 99.5 mass %, more preferably from 70 to 99 mass %, even more preferably from 80 to 96 mass %, and still more preferably from 85 to 95 mass % with respect to the total of the constituent units (100 mass %) of the component (D).

The component (D) may be an acrylic copolymer further containing a constituent unit derived from a functional group-containing monomer (d2) (hereinafter, also referred to as a “monomer (d2)”) in addition to the constituent unit derived from the monomer (d1).

Examples of the monomer (d2) include monomers having a functional group exemplified as the monomer (c22). Among them, when used as the monomer (d2), the carboxyl group-containing monomers are more preferred, Specifically, (meth)acrylic acid is even more preferred, and acrylic acid is still more preferred.

One type of the monomers (d2) may be used alone, or two or more types of the monomers (d2) may be used in combination.

When the component (D) contains a constituent unit derived from the monomer (d2), the constituent unit derived from the monomer (d2) contained in the component (D) accounts for preferably from 0.5 to 40 mass %, more preferably from 1 to 30 mass %, even more preferably from 4 to 20 mass %, and still more preferably from 5 to 15 mass % with respect to the total of the constituent units (100 mass %) of the component (D).

The component (D) may be an acrylic copolymer further containing a constituent unit derived from another monomer (d3) (hereinafter, also referred to as a “monomer (d3)”) other than the monomer (d1) and the monomer (d2) in addition to the constituent unit derived from the monomer (d1); or an acrylic copolymer further containing a constituent unit derived from the monomer (d3) in addition to the constituent units derived from the monomer (d1) and the monomer (d2).

Examples of the monomer (d3) include those exemplified as the aforementioned monomer (c23).

One type of the monomers (d3) may be used alone, or two or more types of the monomers (d3) may be used in combination.

When the component (D) contains a constituent unit derived from the monomer (d3), how much the constituent unit derived from the monomer (d3) is contained in the component (D) is preferably from 0.5 to 40 mass %, more preferably from 1 to 30 mass %, even more preferably from 4 to 20 mass %, and still more preferably from 5 to 15 mass % with respect to the total of the constituent units (100 mass %) of the component (D).

When the component (D) contains a constituent unit derived from one or more selected from the monomer (d2) and the monomer (d3) in addition to the constituent unit derived from the monomer (d1), the total content of the constituent unit derived from one or more selected from the monomer (d2) and the monomer (d3) and the constituent unit content derived from the monomer (d1) is preferably from 80 to 100 mass %, more preferably from 90 to 100 mass %, even more preferably from 95 to 100 mass %, and still more preferably from 98 to 100 mass %, and may be 100 mass %, with respect to the total of the constituent units (100 mass %) of the component (D).

Moreover, when the component (D) is an acrylic copolymer containing a constituent unit derived from a plurality of monomers (d1); or an acrylic copolymer containing a constituent unit derived from one or more selected from one or more monomers (d2) and one or more monomers (d3) and a constituent unit derived from one or more monomers (d1), the form of copolymerization is not particularly limited, and may be a block copolymer or a random copolymer.

Furthermore, in an aspect of the present invention, when the pressure sensitive adhesive composition (II) is used as a hot melt pressure sensitive adhesive, the component (D) preferably contains substantially no radical reactive unsaturated double bond.

In a case where the component (D) contains substantially no radical reactive unsaturated double bond, when the pressure sensitive adhesive composition (II) is heated, the polymerization reaction of the component (D) is prevented or suppressed, and it becomes possible to suppress an increase in the viscosity of the pressure sensitive adhesive composition (II) over time. As a result, the pot life of the pressure sensitive adhesive composition can be extended, which is preferable.

The “radical reactive unsaturated double bond” means an unsaturated double bond capable of participating in a radical reaction by heating or energy irradiation, and includes both an unsaturated double bond which reacts with a radical generated from a component other than the component (D) such as an initiator to generate an active site of the radical reaction and an unsaturated double bond which itself is activated by heating or energy irradiation to generate a radical to initiate the reaction.

Examples of the radical reactive unsaturated double bond include a radical reactive carbon-carbon double bond. Moreover, examples of the functional group containing a radical reactive carbon-carbon double bond include a (meth)acryloyl group, a vinyl group, and an allyl group.

When the component (D) “contains substantially no radical reactive unsaturated double bond”, it means that, for example, the constituent unit derived from the monomer having a radical reactive unsaturated double bond even after the polymerization accounts for preferably 1.0 mass % or less, more preferably 0.1 mass % or less, and even more preferably 0.05 mass % or less with respect to the total of the constituent units (100 mass %) of the component (D).

In the present specification, how much the constituent unit of the monomer is contained with respect to the total of the constituent units (100 mass %) of the component (D) can also be regarded as how much the monomer is contained with respect to 100 mass % of the total amount of the monomers blended when synthesizing the component (D).

In addition, unless otherwise stated, the total of the constituent units (100 mass %) of the component (D) do not include, for example, a constituent unit derived from a polymerization initiator and a chain transfer agent used in the polymerization of the polymer.

Meanwhile, for example, in an aspect of the present invention, when the pressure sensitive adhesive composition (II) is diluted with a solvent and applied, the weight average molecular weight (Mw) of the component (D) is not particularly limited as long as the effects of the present invention are exerted. However, the weight average molecular weight (Mw) is, for example, preferably from 10000 to 2000000, more preferably from 50000 to 1500000, and even more preferably from 100000 to 1000000.

Moreover, for example, in an aspect of the present invention, when the pressure sensitive adhesive composition (II) is melted and applied as a hot melt pressure sensitive adhesive, the weight average molecular weight (Mw) of the component (D) is preferably 280000 or less from the viewpoint of further improving the applicability of the pressure sensitive adhesive composition (II).

From the viewpoint of further improving the applicability of the pressure sensitive adhesive composition (II), the weight average molecular weight (Mw) of the component (D) is more preferably 270000 or less and even more preferably 260000 or less. Furthermore, the weight average molecular weight (Mw) of the component (B) is preferably 1000 or more, more preferably 5000 or more, and even more preferably 10000 or more.

The component (D) contained in the pressure sensitive adhesive composition (II) accounts for preferably 50 mass % or more, more preferably 70 mass % or more, and even more preferably 80 mass % or more, and preferably 99 mass % or less, more preferably 98 mass % or less, and even more preferably 97 mass % or less with respect to 100 mass % of the total amount of the pressure sensitive adhesive composition (II).

Moreover, the pressure sensitive adhesive composition (II) may further contain a polymer other than the component (D) in addition to the component (D). The polymer other than the component (D) is not particularly limited as long as the effects of the present invention are exerted, and examples thereof include an acrylic polymer other than the component (D) and the component (E) described later.

Furthermore, if necessary, one or more components selected from the additional components described later may be contained.

### {Hydrogen Abstraction Type Photoinitiator (B)}

The hydrogen abstraction type photoinitiator (B) contained in the pressure sensitive adhesive composition (II) is the same as the component (B) previously described in the section of the resin film, and specific examples thereof are also the same as those previously mentioned. Among them, a compound containing benzophenone is preferably used from the viewpoint of ease of radical generation.

In the pressure sensitive adhesive composition (II), one type of component (B) may be used alone, or two or more types of components (B) may be used in combination.

Moreover, the component (B) contained in the resin film and the component (B) contained in the pressure sensitive adhesive composition layer (II) may be the same as or different from each other.

How much the component (B) in the pressure sensitive adhesive composition (II) is not particularly limited as long as the effects of the present invention are exerted. However, the component (B) in the pressure sensitive adhesive composition (II) accounts for, for example, preferably 0.1 parts by mass or more, more preferably 0.3 parts by mass or more, and even more preferably 0.5 parts by mass or more, and preferably 10 parts by mass or less, more preferably 9 parts by mass or less, and even more preferably 8 parts by mass or less, with respect to 100 parts by mass of the component (D), from the viewpoint of producing a pressure sensitive adhesive sheet that can be detached without further fouling of an adherend.

From the viewpoint that the effects of the present invention are more easily exerted, the total content of the component (D) and the component (B) in the pressure sensitive adhesive composition (II) is preferably 70 mass % or more, more preferably 80 mass % or more, even more preferably 90 mass % or more, and still more preferably 95 mass % or more, and 100% by mass or less with respect to 100 mass % of the total amount of the pressure sensitive adhesive composition (II).

### [Other Energy Ray-Crosslinkable Pressure Sensitive Adhesive Composition]

In an aspect of the present invention, other energy ray pressure sensitive adhesive compositions other than the aforementioned pressure sensitive adhesive compositions (I) and (II) may be used.

Examples of the other energy ray pressure sensitive adhesive compositions include a pressure sensitive adhesive composition (E) containing, as the main component, an energy ray-curable pressure sensitive adhesive resin other than the component (C) having an energy ray-polymerizable functional group introduced into a side chain thereof (hereinafter, also referred to as a component (E)).

Examples of the pressure sensitive adhesive resin in the component (E) include a rubber-based resin such as a polyisobutylene-based resin, a urethane-based resin, a polyester-based resin, an olefin-based resin, a silicone-based resin, and a polyvinyl ether-based resin. When these pressure sensitive adhesive resins are copolymers having two or more constituent units, the form of the copolymer is not particularly limited. The copolymer may be any of a block copolymer, a random copolymer, or a graft copolymer.

The energy ray-polymerizable functional group in the component (E) is only required to be a group containing an energy ray-polymerizable carbon-carbon double bond, and examples thereof include a (meth)acryloyl group, a vinyl group, and an allyl group.

When the pressure sensitive adhesive composition containing the component (E) is used, an initiator that generates a radical by an energy ray, such as a photopolymerization initiator, may be further contained. Furthermore, a crosslinking agent may be contained. Examples of the photopolymerization initiator and the crosslinking agent are the same as those exemplified in the section of the pressure sensitive adhesive composition (II).

The component (E) is preferably a polymer having adhesiveness by itself. The weight average molecular weight (Mw) of the pressure sensitive adhesive resin (E), which is the component (E), is not particularly limited as long as the effects of the present invention are exerted. However, the weight average molecular weight (Mw) is, for example, preferably from 10000 to 2000000.

### {Additional Components}

Each of the aforementioned pressure sensitive adhesive compositions may or may not contain an additional component other than the aforementioned components as long as the effects of the present invention are exerted.

Examples of the additional component include: a tackifier; an antioxidant; a softening agent; and an additive for a pressure sensitive adhesive used in a widely-used pressure sensitive adhesive.

One type of each of these additional components may be used alone, or two or more types of these additional components may be used in combination.

The tackifier is a component that can improve the adhesive properties of the resulting pressure sensitive adhesive, and is not particularly limited as long as the effects of the present invention are exerted. Known tackifiers can be used. Examples thereof include rosin-based resins and hydrides thereof (hydrogenated rosin-based resins), terpene-based resins and hydrides thereof (hydrogenated terpene-based resins), petroleum resins and hydrides thereof (hydrogenated petroleum resins), and styrene-based resins and hydrides thereof (hydrogenated styrene-based resins).

One type of the tackifier may be used alone, or two or more types of the tackifiers may be used in combination.

The softening point of the tackifier is preferably from 70 to 140° C. Note that, in the present specification, the softening point of the tackifier means a value measured in accordance with JIS K 5601-2-2; 1999.

The antioxidant is not particularly limited, and known antioxidants can be used. Examples thereof include a hindered phenol-based antioxidant, a sulfur-based antioxidant, and a phosphorus-based antioxidant.

One type of the antioxidant may be used alone, or two or more types of the antioxidants may be used in combination.

Examples of the additive for a pressure sensitive adhesive used in a widely-used pressure sensitive adhesive include wax, a filler, an extender, a thermal stabilizer, a light stabilizer, an ultraviolet absorber, a colorant (such as a pigment and a dye), a flame retardant, an antistatic agent, a stringiness retarder, a leveling agent, a crosslinking agent, a crosslinking aid, an antioxidant, inorganic particles, organic particles, and a weight-reducing agent.

One type of these additives for a pressure sensitive adhesive may be used alone, or two or more types of these additives for a pressure sensitive adhesive may be used in combination.

However, when the pressure sensitive adhesive composition contains one or more types selected from the additional components, the total content of the aforementioned components and the additional components in the pressure sensitive adhesive composition is 100 mass % or less with respect to 100 mass % of the total amount of the pressure sensitive adhesive composition.

When the pressure sensitive adhesive composition (II) is used as the pressure sensitive adhesive composition and the pressure sensitive adhesive composition is a hot melt type, the pressure sensitive adhesive composition preferably contains substantially no compound having a radical reactive unsaturated double bond, such as polyfunctional acrylate, from the viewpoint of suppressing an increase in viscosity during long-term heating. Herein, when the pressure sensitive adhesive composition “contains substantially no compound having a radical reactive unsaturated double bond”, it means that, for example, the compound having a radical reactive unsaturated double bond accounts for preferably 1.0 mass % or less, more preferably 0.1 mass % or less, and even more preferably 0.05 mass % or less with respect to 100 mass % of the total amount of the pressure sensitive adhesive composition.

### [Method for Producing Pressure Sensitive Adhesive Composition]

As an aspect of producing the pressure sensitive adhesive composition, for example, the pressure sensitive adhesive composition may be produced by a kneading method in which the aforementioned components are melt-kneaded.

In a case of melt-kneading, for example, the components are charged into a mixing device equipped with a heating device, such as a heating kneader, and mixed in a state in which the components are melted.

Examples of the mixing device equipped with a heating device include a single-screw extruder, a twin-screw extruder, a rolling mill, a Banbury mixer, an intermix, and a pressure kneader.

In a case where a mixing device that can reduce pressure is used, as necessary, the pressure in the inside of the mixing device may be reduced, and the melt-kneading may be performed under reduced pressure.

The kneading temperature at the time of the melt-kneading is not particularly limited, and a temperature condition under which the components are sufficiently mixed in a melted state is appropriately selected. The kneading temperature is preferably from 80 to 180° C., more preferably from 100 to 170° C., and even more preferably from 120 to 150° C.

Note that, when the pressure sensitive adhesive composition is produced by melt-kneading, the pressure sensitive adhesive composition does not need to contain a solvent. From the viewpoint of reducing environmental load, the pressure sensitive adhesive composition preferably contains substantially no solvent and more preferably contains no solvent. Herein, when the pressure sensitive adhesive composition “contains substantially no solvent” means that, for example, the solvent accounts for preferably 0.5 mass % or less, more preferably 0.1 mass % or less, and even more preferably 0.05 mass % or less with respect to 100 mass % of the total amount of the pressure sensitive adhesive composition.

Note that, “melt-kneading” according to the method for producing the pressure sensitive adhesive composition includes a case where only one component is contained as a component of the pressure sensitive adhesive composition and the component is melted and used.

The pressure sensitive adhesive composition produced after completion of the melt-kneading may be applied while being in a heat-melted state on at least one surface of the resin film or a release liner with an extruder or the like and subjected to production of the pressure sensitive adhesive sheet which is an aspect of the present invention described later.

As an aspect of producing the pressure sensitive adhesive composition, for example, the pressure sensitive adhesive composition may be produced through a step of mixing or dispersing the aforementioned components in an organic solvent for dilution to form a liquid matter such as a solution or a sol of the pressure sensitive adhesive composition.

Examples of the organic solvent for dilution include methyl ethyl ketone, acetone, ethyl acetate, tetrahydrofuran, cyclohexane, n-hexane, toluene, xylene, n-propanol, and isopropanol.

Note that, as for the organic solvent to be used, for example, the organic solvent used in the synthesis of the polymer such as the component (C) and the component (D) contained in the pressure sensitive adhesive composition may be used as it is, or one or more types of organic solvents other than the organic solvent used in the synthesis of the polymer may be added.

When a liquid of the pressure sensitive adhesive composition is used, the organic solvent in the liquid of the pressure sensitive adhesive composition accounts for preferably from 30 to 90 mass %, more preferably from 40 to 85 mass %, and even more preferably from 50 to 80 mass %.

In addition, each of the pressure sensitive adhesive composition layer in the first pressure sensitive adhesive sheet and the pressure sensitive adhesive layer in the second pressure sensitive adhesive sheet may be made of a single layer or a plurality of layers.

The thickness of the pressure sensitive adhesive composition layer in the first pressure sensitive adhesive sheet and the thickness of the pressure sensitive adhesive layer in the second pressure sensitive adhesive sheet are each independently preferably from 5 to 100 μm, more preferably from 10 to 60 μm, and even more preferably from 15 to 30 μm.

With a thickness of 5 μm or more, the pressure sensitive adhesive composition layer and the pressure sensitive adhesive layer tend to facilitate further improvement of the adhesive strength. Furthermore, when the thickness of the pressure sensitive adhesive composition layer or the pressure sensitive adhesive layer is 100 μm or less, even better handleability tends to be achieved.

Herein, the “thickness of the pressure sensitive composition layer” means the thickness of the entire pressure sensitive adhesive composition layer. For example, when a pressure sensitive adhesive composition layer in which two or more layers are laminated is used, the thickness of the pressure sensitive composition layer means the total thickness of all layers of the pressure sensitive adhesive composition layer. The same applies to the “thickness of the pressure sensitive adhesive layer”.

Herein, the laminate of the substrate and the pressure sensitive adhesive layer of the second pressure sensitive adhesive sheet is formed by performing the energy ray irradiation on the laminate of the resin film and the energy ray-crosslinkable pressure sensitive adhesive composition layer. That is, it is necessary to perform the energy ray irradiation after laminating the resin film and the energy ray-crosslinkable pressure sensitive adhesive composition layer.

By performing the energy ray irradiation after laminating the resin film and the energy ray-crosslinkable pressure sensitive adhesive composition layer, a crosslinking reaction of the energy ray-crosslinkable pressure sensitive adhesive composition layer and a reaction of generating a radical on the component (A) based on the component (A) and the component (B) in the aforementioned resin film proceed roughly simultaneously.

Accordingly, it is considered that the component (A) in the resin film directly undergoes a crosslinking reaction with the polymer components in the pressure sensitive adhesive composition, thereby improving the adhesion at the interface between the substrate and the pressure sensitive adhesive layer in the second pressure sensitive adhesive sheet formed by the energy ray irradiation. As a result, the second pressure sensitive adhesive sheet becomes a pressure sensitive adhesive sheet which is excellent in substrate adhesion and can be detached without fouling of an adherend.

Therefore, for example, even when the resin film is irradiated with an energy ray to form a substrate in advance before the resin film and the energy ray-crosslinkable pressure sensitive adhesive composition layer are laminated, and then the energy ray-crosslinkable pressure sensitive adhesive composition layer is laminated on the substrate and irradiated with an energy ray to form a pressure sensitive adhesive layer, the effects of the present invention cannot be sufficiently exerted.

Alternatively, the same applies to a case where a pressure sensitive adhesive layer formed separately by irradiating the energy ray-crosslinkable pressure sensitive adhesive composition layer with an energy ray in advance is laminated on the substrate.

The reason is considered to be that the crosslinking reaction in each layer is almost completed, and the reaction with the components of the other layer via the interface of each layer is hardly possible.

As previously mentioned, in the laminate of the substrate and the pressure sensitive adhesive layer of the second pressure sensitive adhesive sheet, it is considered that at the interface between the substrate and the pressure sensitive adhesive layer, a molecular structure in which the components of the layers react with each other is formed. Therefore, from a very microscopic viewpoint, it is considered that there is also a difference in structure between the laminate of the substrate and the pressure sensitive adhesive layer, which is produced by laminating the resin film and the energy ray-crosslinkable pressure sensitive adhesive composition layer and then performing the energy ray irradiation, and the aforementioned laminate of the substrate and the pressure sensitive adhesive layer, which is produced by, for example, performing the energy ray irradiation on any one or two layers before laminating the resin film and the energy ray-crosslinkable pressure sensitive adhesive composition layer.

However, it can be said that it is very difficult to evaluate, for example, the molecular structure or the like in the vicinity of the interface between the substrate and the pressure sensitive adhesive layer of the resulting laminate and to make a distinction based on the difference in the microscopic structure or the like. At present, it is also practically difficult to clearly analyze and specify a reaction site or the like in a molecule in each layer. Therefore, since it is impossible or impractical to directly specify the laminate by a specific chemical structure or the like in the technology at the present time, the laminate of the substrate and the pressure sensitive adhesive layer of the second pressure sensitive adhesive sheet is specified by the production method thereof.

### Release Liner

As the release liner, a release liner subjected to double-sided release treatment, a release liner subjected to single-sided release treatment, or the like is used. Examples include a release liner produced by applying a release agent on a substrate for a release liner.

Examples of the substrate for a release liner include paper, such as wood-free paper, glassine paper, and kraft paper; and plastic films, such as polyester resin films of a poly(ethylene terephthalate) resin, a poly(butylene terephthalate) resin, a poly(ethylene naphthalate) resin, or the like, and polyolefin resin films of a polypropylene resin, a polyethylene resin, or the like.

Examples of the release agent include a rubber-based elastomer, such as a silicone-based resin, an olefin-based resin, an isoprene-based resin, and a butadiene-based resin; a long-chain alkyl-based resin; an alkyd-based resin; and a fluorine-based resin.

The thickness of the release liner is not particularly limited, but is preferably from 10 to 200 μm, more preferably from 20 to 180 μm, and even more preferably from 30 to 150 μm.

### Method for Producing First Pressure Sensitive Adhesive Sheet

The method for producing the first pressure sensitive adhesive sheet is not particularly limited, and examples thereof include a method for producing a pressure sensitive adhesive sheet including the following Steps 1 and 2.

That is, a method for producing a pressure sensitive adhesive sheet including a laminate of a resin film and an energy ray-crosslinkable pressure sensitive adhesive composition layer made of an energy ray-crosslinkable pressure sensitive adhesive composition, in which the resin film contains a polymer (A) and a hydrogen abstraction type photoinitiator (B), and the component (A) is a polymer from which the hydrogen abstraction type photoinitiator (B) is capable of abstracting a hydrogen, the method including, the following Steps 1 and 2 in this order:
Step 1: a step of forming a resin film containing a polymer (A) and a hydrogen abstraction type photoinitiator (B); and
Step 2: a step of laminating the resin film produced in Step 1 and an energy ray-crosslinkable pressure sensitive adhesive composition layer made of an energy ray-crosslinkable pressure sensitive adhesive composition to form a laminate of the resin film and the energy ray-crosslinkable pressure sensitive adhesive composition layer.

### (Step 1)

The resin film produced in Step 1 is the same as the resin film according to an aspect of the present invention, and preferred aspects thereof are also the same.

Therefore, the description of Step 1 is the same as the description in the method for producing the resin film according to an aspect of the present invention.

### (Step 2)

The energy ray-crosslinkable pressure sensitive adhesive composition layer made of the energy ray-crosslinkable pressure sensitive adhesive composition formed in Step 2 is the same as the pressure sensitive adhesive composition layer described in the section of the pressure sensitive adhesive sheet according to an aspect of the present invention, and preferred aspects thereof are also the same.

Therefore, the method for producing the energy ray-crosslinkable pressure sensitive adhesive composition used in Step 2 is also the same as the description in the method for producing the pressure sensitive adhesive composition according to an aspect of the present invention.

Then, Step 2 includes, for example, the following Step 2A or Step 2B.

Step 2A: a step of forming an energy ray-crosslinkable pressure sensitive adhesive composition layer made of the energy ray-crosslinkable pressure sensitive adhesive composition directly on at least one surface of the resin film produced in Step 1 to form a laminate of the resin film and the energy ray-crosslinkable pressure sensitive adhesive composition layer.

Step 2B: a step of forming an energy ray-crosslinkable pressure sensitive adhesive composition layer made of an energy ray-crosslinkable pressure sensitive adhesive composition on a release liner, and then attaching an exposed surface of the pressure sensitive adhesive composition layer to at least one surface of the resin film produced in Step 1 to form a laminate of the resin film and the energy ray-crosslinkable pressure sensitive adhesive composition layer.

In Step 2A or Step 2B, as for the energy ray-crosslinkable pressure sensitive adhesive composition, examples of the method for forming the pressure sensitive adhesive composition layer on at least one surface of the resin film produced in Step 1 or on the release liner include the following methods.

For example, the pressure sensitive adhesive composition layer may be formed by applying the energy ray-crosslinkable pressure sensitive adhesive composition produced by melt-kneading to at least one surface of the resin film produced in Step 1 or to the release liner while being in a heat-melted state. Moreover, as necessary, a step of cooling the pressure sensitive adhesive composition layer may be included after the pressure sensitive adhesive composition is formed. An extruder, a T-die, or the like can be used for the application.

Alternatively, for example, the pressure sensitive adhesive composition layer may be formed by applying a liquid of the energy ray-crosslinkable pressure sensitive adhesive composition, such as a solution or sol of the energy ray-crosslinkable pressure sensitive adhesive composition, to at least one surface of the resin film produced in Step 1 or to a release liner to form a coating film made of the pressure sensitive adhesive composition, and then subjecting the coating film to either or both of drying treatment and heating treatment.

Examples of applying the liquid of the energy ray-crosslinkable pressure sensitive adhesive composition to the support or the release liner include a spray coating method, a bar coating method, a knife coating method, a roll coating method, a blade coating method, a die coating method, and a gravure coating method.

Moreover, the method and temperature for performing either or both drying treatment and heating treatment on the coating film made of the pressure sensitive adhesive composition are not particularly limited, and may be appropriately selected depending on the properties of the material forming the pressure sensitive adhesive composition, and the like.

Therefore, each treatment temperature is not particularly limited as long as the pressure sensitive adhesive composition layer is formed by drying the coating film. However, the temperature is, for example, more preferably lower than boiling points of components of the energy ray-crosslinkable pressure sensitive adhesive composition.

Furthermore, for example, when the liquid of the energy ray-crosslinkable pressure sensitive adhesive composition contains the organic solvent, the temperature for each treatment is more preferably equal to or higher than the boiling point of the organic solvent and lower than the boiling points of the components contained in the energy ray-crosslinkable pressure sensitive adhesive composition.

### Method for Producing Second Pressure Sensitive Adhesive Sheet

The method for producing the second pressure sensitive adhesive sheet is not particularly limited, but includes at least a step of performing energy ray irradiation on a laminate of a resin film and an energy ray-crosslinkable pressure sensitive adhesive composition layer made of an energy ray-crosslinkable pressure sensitive adhesive composition to form a laminate of a substrate and a pressure sensitive adhesive layer.

Herein, the laminate of the resin film and the energy ray-crosslinkable pressure sensitive adhesive composition layer made of the energy ray-crosslinkable pressure sensitive adhesive composition in this step is the same as that of the first pressure sensitive adhesive sheet, and preferred aspects thereof are also the same.

Accordingly, an aspect of a method for producing the second pressure sensitive adhesive sheet includes, for example, a method for producing a pressure sensitive adhesive sheet having the following Steps 1 to 3.

A method for producing a pressure sensitive adhesive sheet including a laminate of a substrate and a pressure sensitive adhesive layer, in which the substrate is formable by irradiating a resin film containing a polymer (A) and a hydrogen abstraction type photoinitiator (B) with an energy ray, the component (A) is a polymer from which the hydrogen abstraction type photoinitiator (B) is capable of abstracting a hydrogen, the pressure sensitive adhesive layer is formable by irradiating an energy ray-crosslinkable pressure sensitive adhesive composition layer made of an energy ray-crosslinkable pressure sensitive adhesive composition with an energy ray, and the laminate of the substrate and the pressure sensitive adhesive layer is formed by irradiating a laminate of the resin film and the energy ray-crosslinkable pressure sensitive adhesive composition layer with the energy ray, the method for producing the pressure sensitive adhesive sheet has the following Steps 1 to 3 in this order.
Step 1: a step of forming a resin film containing a polymer (A) and a hydrogen abstraction type photoinitiator (B);
Step 2: a step of laminating the resin film produced in Step 1 and an energy ray-crosslinkable pressure sensitive adhesive composition layer made of an energy ray-crosslinkable pressure sensitive adhesive composition to form a laminate of the resin film and the energy ray-crosslinkable pressure sensitive adhesive composition layer; and
Step 3: a step of irradiating the laminate produced in Step 2 of the resin film and the energy ray-crosslinkable pressure sensitive adhesive composition layer made of the energy ray-crosslinkable pressure sensitive adhesive composition with an energy ray to form a laminate of a substrate and a pressure sensitive adhesive layer.

The description of Step 1 and Step 2 in the production method is the same as that of Step 1 and Step 2 described in the method for producing the first pressure sensitive adhesive sheet, and preferred aspects thereof are also the same.

### (Step 3)

In Step 3, the timing at which the energy ray irradiation is performed is not particularly limited and is to be appropriately determined in consideration of the method for producing the pressure sensitive adhesive sheet, desired physical properties, and the like.

For example, in a state where one surface of the laminate is exposed, the laminate may be irradiated with an energy ray directly or through the support or the release liner, or in a state where the laminate has the support or the release liner on one surface and the release liner on the other surface, the laminate may be irradiated with an energy ray through the support or the release liner.

However, when energy ray irradiation is performed through the support or the release liner, the support or the release liner preferably has transparency to such an extent that the resin film and the energy ray-crosslinkable pressure sensitive adhesive composition layer are sufficiently irradiated with an energy ray.

Moreover, in Step 3, the energy ray irradiation is preferably performed from the surface of the laminate on the pressure sensitive adhesive composition layer side. In this case, even if the resin film does not have transparency, the surface of the resin film in contact with the pressure sensitive adhesive composition layer is easily irradiated with energy through the pressure sensitive adhesive composition layer, and the component (B) in the resin film reacts to easily generate a radical serving as a reaction initiation point on the component (A). Similarly, when the release liner is attached onto the pressure sensitive adhesive composition layer, it is preferable that the release liner be detached to expose the surface of the pressure sensitive adhesive composition layer, and then the exposed surface be irradiated with an energy ray. Alternatively, when the energy ray irradiation is performed through the release liner, it is preferable to use a release liner with high energy ray transmittance.

Furthermore, the energy ray irradiation may be performed on the laminate once or for a plurality of times.

In addition, the irradiation conditions such as the type, illuminance, and light amount of the energy ray can be selected as appropriate depending on the properties of the materials forming the resin film and the pressure sensitive adhesive composition layer, and the like. For example, the component (B) contained in each layer reacts with the energy ray, and the irradiation can be performed under the condition that the aforementioned reaction can be started.

### [Application of Pressure Sensitive Adhesive Sheet]

The first pressure sensitive adhesive sheet and the second pressure sensitive adhesive sheet according to an aspect of the present invention can be used for various applications. The first pressure sensitive adhesive sheet can be used as the second pressure sensitive adhesive sheet by irradiation with an energy ray immediately before or after being attached to an adherend. However, from the viewpoint that the effects of the present invention are more easily exerted, it is preferable to form the second pressure sensitive adhesive sheet in advance and then attach the second pressure sensitive adhesive sheet to the adherend.

Specific examples include label applications; applications for fixing or temporarily fixing various components; surface protection applications; sealing material applications; and decoration and display applications.

Among these, label applications and applications for fixing or temporarily fixing various components are preferred.

The pressure sensitive adhesive sheet for label applications may be directly adhered to various products or may be adhered to packaging films and packaging containers of various products, and the like. Examples of the constitutional material of the packaging film and the packaging container include an olefin-based resin such as polypropylene and polyethylene; a polyester-based resin such as polyethylene terephthalate (PET) and polylactic acid; glass, paper, and metal.

The pressure sensitive adhesive sheet for applications for fixing or temporary fixing is suitable for fixing or temporarily fixing, for example, electronic members, optical members, automobile components, mechanism components, construction members, or decorative members.

### EXAMPLES

The present invention will be specifically described with reference to Examples below, but the present invention is not limited to the following Examples. Physical property values in examples are values measured by the following methods.

### [Weight Average Molecular Weight (Mw)]

The weight average molecular weight (Mw) was measured using a gel permeation chromatograph device under the following conditions and determined in terms of standard polystyrene.

### (Measurement Device)

Measurement device: product name “HLC-8320GPC” available from Tosoh Corporation
Detector: differential refractometer
Columns: one “TSK guard column super H-H”, two “TSK gel super HM-H” in series, and one “TSK gel super H2000” (all available from Tosoh Corporation) were connected in this order from the inlet side of the measurement sample and used.
   (Measurement conditions)
Column temperature: 40° C.
Developing solvent: tetrahydrofuran
Flow rate: 1.0 mL/min

### [Thickness of Each Layer]

The thickness of each layer was measured at 23° C. by using a constant pressure thickness meter (model number: “PG-02J”, standard specifications: in accordance with JIS K 6783, Z 1702, and Z 1709) available from Teclock.

### Example 1

### (Production of First Pressure Sensitive Adhesive Sheet)

A sol of a composition for forming a resin film was produced by dispersing 30 parts by mass of an adipic acid-based polyester plasticizer (product name “Adekacizer (trade name) P-200” available from ADEKA CORPORATION) and 1 part by mass of a hydrogen abstraction type photoinitiator (4-methylbenzophenone, product name “SpeedCure (trade name) MBP” available from Lambson) in ethylene glycol monobutyl ether serving as an organic solvent with respect to 100 parts by mass of polyvinyl chloride having an average degree of polymerization of 1600 (product name “Ryuron Paste (trade name) 860” available from Tosoh Corporation). The percentage of the organic solvent in the sol of the resulting resin film forming composition was 30 mass %.

The sol of the resin film forming composition thus produced was applied to the release agent-treated surface of a release liner made of polyethylene terephthalate by a casting method using a knife coater, and heated at 140° C. for one minute and at 190° C. for two minutes to prepare a resin film with a thickness of 50 μm.

Next, an acrylic polymer (product name “acResin (trade name) A204UV” available from BASF, weight average molecular weight (Mw)=187000) having a benzophenone structure in a side chain and serving as the pressure sensitive adhesive composition (I) was melt-applied at 130° C. on the surface of the resin film opposite to the side on which the release liner was provided, by using a slot die coater to form an energy ray-crosslinkable pressure sensitive adhesive composition layer such that the coating thickness became 25 μm, and a first pressure sensitive adhesive sheet in which the resin film and the energy ray-crosslinkable pressure sensitive adhesive composition layer were laminated in this order from the release liner side was produced.

### (Production of Second Pressure Sensitive Adhesive Sheet)

The energy ray-crosslinkable pressure sensitive adhesive composition layer of the resulting first pressure sensitive adhesive sheet was irradiated with an ultraviolet ray from the exposed surface side thereof by using a high-pressure mercury lamp under a condition of an integrated light quantity of 100 mJ/cm² in the UV-C region. By the irradiation, a laminate of a substrate formed from the resin film of the first pressure sensitive adhesive sheet and a pressure sensitive adhesive layer formed from the energy ray-crosslinkable pressure sensitive adhesive composition layer was prepared.

Next, a release liner was laminated on the exposed surface of the pressure sensitive adhesive layer, and then the release liner on the substrate was detached and removed to produce the second pressure sensitive adhesive sheet in which the substrate and the pressure sensitive adhesive layer were laminated in this order and the surface of the pressure sensitive adhesive layer was protected by the release liner.

### Examples 2 to 4

In each of Examples 2 to 4, the first pressure sensitive adhesive sheet and the second pressure sensitive adhesive sheet were prepared in the same manner as in Example 1 except that a substrate was used in which the amount of the hydrogen abstraction type photoinitiator in the resin film forming composition in Example 1 was changed to the amount shown in Table 1 below.

### Example 5

### (Production of Energy-Ray-Crosslinkable Pressure Sensitive Adhesive Composition)

An energy ray-crosslinkable pressure sensitive adhesive composition (II) was produced by kneading 100 parts by mass of an acrylate copolymer (n-butyl acrylate (BA)/acrylic acid (AA)=90/10, weight average molecular weight (Mw)=250000) and 5 parts by mass of a hydrogen abstraction type photoinitiator (4-methylbenzophenone, product name “SpeedCure (trade name) MBP” available from Lambson) with a heating kneader at 130° C. for 20 minutes under nitrogen purge.

### (Production of First and Second Pressure Sensitive Adhesive Sheets)

A first pressure sensitive adhesive sheet and a second pressure sensitive adhesive sheet were prepared in the same manner as in Example 1 except that the energy ray-crosslinkable pressure sensitive adhesive composition (II) was used instead of the acrylic polymer having a benzophenone structure in a side chain.

### Example 6

### (Production of First Pressure Sensitive Adhesive Sheet)

A resin film was prepared by a method the same as the method described in Example 1.

Next, on the release agent-treated surface of the release liner, a solution (organic solvent content: 60 mass %) in which the energy ray-crosslinkable pressure sensitive adhesive composition was dissolved in ethyl acetate was applied using a roll knife coater such that the coating thickness after drying was 25 μm, and the solution was dried at 90° C. for one minute to form an energy ray-crosslinkable pressure sensitive adhesive composition layer.

As the energy ray-crosslinkable pressure sensitive adhesive composition, a mixture of 100 parts by mass of an acrylate copolymer (n-butyl acrylate (BA)/acrylic acid (AA)=90/10, weight average molecular weight (Mw)=700000) and 5 parts by mass of a hydrogen abstraction type photoinitiator (4-methylbenzophenone, product name “SpeedCure (trade name) MBP” available from Lambson) was used.

Next, this dried energy ray-crosslinkable pressure sensitive adhesive composition layer was laminated on the surface of the resin film prepared by the aforementioned method on the side opposite to the side on which the support was provided to produce the first pressure sensitive adhesive sheet in which the resin film, the energy ray-crosslinkable pressure sensitive adhesive composition layer, and the release liner were laminated in this order from the release liner side on the resin film.

### (Production of Second Pressure Sensitive Adhesive Sheet)

The release liner on the energy ray-crosslinkable pressure sensitive adhesive composition layer of the resulting first pressure sensitive adhesive sheet was removed, and irradiation with an ultraviolet ray was performed from the exposed surface side using a high-pressure mercury lamp under a condition of an integrated light quantity of 100 mJ/cm² in the UV-C region to form a laminate made of a substrate and a pressure sensitive adhesive layer.

Next, a release liner was laminated on the exposed surface of the pressure sensitive adhesive layer, and then the release liner on the substrate was detached and removed to produce the second pressure sensitive adhesive sheet in which the substrate and the pressure sensitive adhesive layer were laminated in this order and the surface of the pressure sensitive adhesive layer was protected by the release liner.

### Comparative Example 1

A first pressure sensitive adhesive sheet and a second pressure sensitive adhesive sheet were prepared in the same manner as in Example 1 except that the hydrogen abstraction type photoinitiator was not used and a resin film containing no hydrogen abstraction type photoinitiator was used in the preparation of the resin film of Example 1.

### Comparative Example 2

A first pressure sensitive adhesive sheet and a second pressure sensitive adhesive sheet were prepared in the same manner as in Example 5 except that the hydrogen abstraction type photoinitiator was not used and a pressure sensitive adhesive layer made only of the acrylate copolymer was used in the preparation of the pressure sensitive adhesive layer of Example 5.

### Comparative Example 3

In the same manner as in Example 1, a resin film was prepared, and then the exposed surface of the resin film was irradiated with ultraviolet rays by a high-pressure mercury lamp under the condition of an integrated light quantity 100 mJ/cm² in the UV-C region.

Next, an acrylic polymer having a benzophenone structure in a side chain (product name “acResin (trade name) A204UV” available from BASF, weight average molecular weight (Mw)=187000) was melt-applied at 130° C. on the release agent-treated surface of the release liner using a slot die coater, such that the coating thickness became 25 μm, to form an energy ray-crosslinkable pressure sensitive adhesive composition layer, and the exposed surface of the energy ray-crosslinkable pressure sensitive adhesive composition layer was irradiated with an ultraviolet ray by a high-pressure mercury lamp under the condition of the integrated light quantity of 100 mJ/cm² in the UV-C region.

The energy ray-crosslinkable pressure sensitive adhesive composition layer after the ultraviolet irradiation was laminated on the exposed surface of the resin film after the ultraviolet irradiation to prepare a pressure sensitive adhesive sheet.

### [Release Test]

Each of the second pressure sensitive adhesive sheets produced in Examples 1 to 6 and Comparative Examples 1 and 2 and the pressure sensitive adhesive sheet produced in Comparative Example 3 was cut into a size of 25 mm×50 mm in an environment at 23° C. and 50% RH (relative humidity), and two test pieces were prepared. The release sheet of each of the test pieces was removed, and the exposed pressure sensitive adhesive layer was attached to an adherend (stainless plate).

Then, the test pieces attached to the adherend were allowed to stand still in an environment at 23° C. and 50% RH (relative humidity) for seven days. Thereafter, one of the test pieces was detached from the adherend with hands at a speed of approximately 300 mm/min in a 180° direction (low-speed detachment). The other test piece was detached with hands at a speed of approximately 30 m/min in a 180° direction (high-speed detachment).

Then, the state of each of the layers of the test pieces were visually observed after the detachment and confirmed with the following criteria. The results are shown in Table 1 below.

No fouling: detachment occurred at the interface between the pressure sensitive adhesive layer and the adherend, and no pressure sensitive adhesive remained on the adherend, and thus releasability was excellent.

Transfer adhesion: detachment occurred at the interface between the substrate and the pressure sensitive adhesive layer, and remaining of the pressure sensitive adhesive layer was confirmed on the adherend.

Cohesive failure: the pressure sensitive adhesive layer was broken, and remaining of the pressure sensitive adhesive layer was confirmed on the adherend.

Substrate breakage: the substrate was broken, and remaining of the pressure sensitive adhesive sheet was confirmed on the adherend.

TABLE 1

| | | | | Examples | | | | | | Comparative Examples | | |
|---|---|---|---|---|---|---|---|---|---|---|---|---|
| | | | Unit | 1 | 2 | 3 | 4 | 5 | 6 | 1 | 2 | 3 |
| Configuration | Resin film | PVC | Parts by | 100 | 100 | 100 | 100 | 100 | 100 | 100 | 100 | 100 |
| of pressure | (*1) | | mass | | | | | | | | | |
| sensitive | | Plasticizer | Parts by | 30 | 30 | 30 | 30 | 30 | 30 | 30 | 30 | 30 |
| adhesive | | | mass | | | | | | | | | |
| sheet | | Photo- | Parts by | 1 | 0.5 | 5 | 11 | 1 | 1 | — | 1 | 1 |
| | | initiator | mass | | | | | | | | | |
| | Energy | A204UV | Parts by | 100 | 100 | 100 | 100 | — | — | 100 | — | 100 |
| | ray-crosslink | | mass | | | | | | | | | |
| | able pressure | P(BA/AA)-1 | Parts by | — | — | — | — | 100 | — | — | — | — |
| | sensitive | Mw: 25000 | mass | | | | | | | | | |
| | adhesive | P(BA/AA)-2 | Parts by | — | — | — | — | — | 100 | — | 100 | — |
| | composition | Mw: 700000 | mass | | | | | | | | | |
| | layer (*1) | Photo- | Parts by | — | — | — | — | 5 | 5 | — | — | — |
| | | initiator | mass | | | | | | | | | |
| Form of pressure sensitive adhesive | | | | HM | HM | HM | HM | HM | S | HM | HM | HM |
| composition at application (*2) | | | | | | | | | | | | |
| Evaluation | Detachment | Low-speed | | No | No | No | No | No | No | Transfer | Cohesive | Transfer |
| results | test (*3) | detachment | | fouling | fouling | fouling | fouling | fouling | fouling | adhesion | failure | adhesion |
| | | High-speed | | No | No | No | Substrate | No | No | Transfer | Cohesive | Transfer |
| | | detachment | | fouling | fouling | fouling | breakage | fouling | fouling | adhesion | failure | adhesion |

(*1): first pressure sensitive adhesive sheet (before energy ray irradiation).
(*2): “hm” = hot melt. “s” = solution.
(*3): second pressure sensitive adhesive sheet (after energy ray irradiation)

Note that the components denoted by the abbreviations in Table 1 are the aforementioned components shown below.
PVC: polyvinyl chloride having an average degree of polymerization of 1600 (product name “Ryuron Paste (trade name) 860” available from Tosoh Corporation)
Plasticizer: adipic acid-based polyester plasticizer (product name “Adekacizer (trade name) P-200” available from ADEKA CORPORATION)
Photoinitiator: hydrogen abstraction type photoinitiator (4-methylbenzophenone, product name “SpeedCure (trade name) MBP” available from Lambson)
A204UV: acrylic polymer having a benzophenone structure in a side chain, product name “acResin (trade name) A204UV” (available from BASF)
P (BA/AA)-1: acrylate copolymer (n-butyl acrylate (BA)/acrylic acid (AA)=90/10, weight average molecular weight (Mw)=250000)
P (BA/AA)-2: acrylate copolymer (n-butyl acrylate (BA)/acrylic acid (AA)=90/10, weight average molecular weight (Mw)=700000)

From Table 1, it was confirmed that the second pressure sensitive adhesive sheets produced in Examples 1 to 6 were excellent in substrate adhesion and could be detached without fouling of the adherend when detached from the adherend after being attached to the adherend under low-speed detachment conditions.

Furthermore, it was also confirmed that the second pressure sensitive adhesive sheets produced in Examples 1 to 3 and Examples 5 and 6 after energy ray irradiation, in which the hydrogen abstraction type photoinitiator in the resin film before ultraviolet irradiation accounted for 10 parts by mass or less with respect to 100 parts by mass of polyvinyl chloride, could be detached from the adherend without fouling of the adherend even under high-speed release conditions after being attached to the adherend.

As for the second pressure sensitive adhesive sheets produced in Examples 1 to 6, it is considered that the adhesion at the interface between the substrate and the pressure sensitive adhesive layer was improved because a radical was generated not only in the energy ray-crosslinkable pressure sensitive adhesive composition layer upon the ultraviolet irradiation for preparing the second pressure sensitive adhesive sheets, but also by the reaction between the hydrogen abstraction type photoinitiator and polyvinyl chloride in the resin film, thereby forming crosslinking between the resin in the resin film and the resin in the energy ray-crosslinkable pressure sensitive adhesive composition layer.

On the other hand, since the second pressure sensitive adhesive sheet produced in Comparative Example 1 did not contain a hydrogen abstraction type photoinitiator in the resin film of the first pressure sensitive adhesive sheet, it was confirmed that when the second pressure sensitive adhesive sheet after the ultraviolet irradiation was detached under low-speed detachment conditions, detachment occurred at the interface between the substrate and the pressure sensitive adhesive layer, resulting in “transfer adhesion” in which the pressure sensitive adhesive layer remained on the adherend.

In addition, since the pressure sensitive adhesive sheet produced in Comparative Example 3 was prepared by not laminating the resin film and the energy ray-crosslinkable pressure sensitive adhesive composition layer, but laminating the layers after irradiating each layer with ultraviolet rays, it was confirmed that “transfer adhesion” occurred similarly to Comparative Example 1.

Moreover, as for the second pressure sensitive adhesive sheet produced in Comparative Example 2, since the pressure sensitive adhesive layer was not formed from an energy ray-crosslinkable pressure sensitive adhesive composition layer, it was confirmed that the pressure sensitive adhesive layer was broken even under the low-speed detachment conditions, causing “cohesive failure” in which the pressure sensitive adhesive layer remained on the adherend.

As described above, it was confirmed that the second pressure sensitive adhesive sheets produced in Examples 1 to 6 were pressure sensitive adhesive sheets that were excellent in substrate adhesion and could be detached without fouling of the adherend. Then, even when polyvinyl chloride is used as the substrate, these effects can be exerted. Therefore, the resin film, the first pressure sensitive adhesive sheet, and the second pressure sensitive adhesive sheet according to each aspect of the present invention, and the production methods thereof can be suitably used even when a low-polarity substrate such as polyvinyl chloride or polyolefin is used.

### REFERENCE SIGNS LIST

1 Energy ray-crosslinkable pressure sensitive adhesive composition layer
2 Resin film
3, 3a, 3b Release liner
4 Pressure sensitive adhesive layer
5 Substrate
6 Support
10a, 20a, 30a First pressure sensitive adhesive sheet
10b, 20b, 30b Second pressure sensitive adhesive sheet

1. A pressure sensitive adhesive sheet, comprising a laminate of:
a substrate; and
a pressure sensitive adhesive layer,
wherein;
the substrate is formable by irradiating a resin film comprising a polymer and a hydrogen abstraction type photoinitiator with an energy ray, wherein the hydrogen abstraction type photoinitiator is capable of abstracting a hydrogen from the polymer,
the pressure sensitive adhesive layer is formable by irradiating an energy ray-crosslinkable pressure sensitive adhesive composition layer comprising an energy ray-crosslinkable pressure sensitive adhesive composition with an energy ray, and
the laminate of the substrate and the pressure sensitive adhesive layer is formed by irradiating a laminate of the resin film and the energy ray-crosslinkable pressure sensitive adhesive composition layer with an energy ray.

2. The pressure sensitive adhesive sheet according to claim 1, wherein the polymer is at least one selected from the group consisting of a polyvinyl chloride-based resin, a polyolefin, an acrylic resin, and a styrene-based resin.

3. The pressure sensitive adhesive sheet according to claim 1, wherein the hydrogen abstraction type photoinitiator in the resin film accounts for 10 parts by mass or less with respect to 100 parts by mass of the polymer.

4. The pressure sensitive adhesive sheet according to claim 1, wherein the polymer in the resin film accounts for 50 mass % or more with respect to 100% by mass of a total of components of the resin film.

5. The pressure sensitive adhesive sheet according to claim 1, wherein the energy ray-crosslinkable pressure sensitive adhesive composition is a first pressure sensitive adhesive composition comprising a first acrylic polymer having energy ray-crosslinkability, or a second pressure sensitive adhesive composition comprising a second acrylic polymer other than the first acrylic polymer and the hydrogen abstraction type photoinitiator.

6. The pressure sensitive adhesive sheet according to claim 5, wherein the first acrylic polymer in the first pressure sensitive adhesive composition has an energy ray-reactive group that reacts by energy ray irradiation and contributes to a formation of a crosslinked structure, and the first acrylic polymer has a benzophenone structure in a side chain.

7. The pressure sensitive adhesive sheet according to claim 5, wherein the first acrylic polymer accounts for from 50 to 100 mass % with respect to 100 mass % of a total amount of the first pressure sensitive adhesive composition.

8. The pressure sensitive adhesive sheet according to claim 5, wherein the second acrylic polymer accounts for 50 mass % or more with respect to 100 mass % of a total amount of the second pressure sensitive adhesive composition.

9. A method for producing the pressure sensitive adhesive sheet according to claim 1, comprising, in the following order:
forming the resin film comprising the polymer and the hydrogen abstraction type photoinitiator;
laminating the resin film and the energy ray-crosslinkable pressure sensitive adhesive composition layer comprising the energy ray-crosslinkable pressure sensitive adhesive composition to form a laminate of the resin film and the energy ray-crosslinkable pressure sensitive adhesive composition layer; and
irradiating the laminate of the resin film and the energy ray-crosslinkable pressure sensitive adhesive composition layer comprising the energy ray-crosslinkable pressure sensitive adhesive composition with an energy ray to form the laminate of the substrate and the pressure sensitive adhesive layer.

10. A pressure sensitive adhesive sheet, comprising a laminate of:
a resin film; and
an energy ray-crosslinkable pressure sensitive adhesive composition layer comprising an energy ray-crosslinkable pressure sensitive adhesive composition,
wherein:
the resin film comprises a polymer and a hydrogen abstraction type photoinitiator, wherein the hydrogen abstraction type photoinitiator is capable of abstracting a hydrogen from the polymer.

11. A resin film comprising:
a polymer; and
a hydrogen abstraction type photoinitiator,
wherein:
the hydrogen abstraction type photoinitiator is capable of abstracting a hydrogen from the polymer.

12. The pressure sensitive adhesive sheet according to claim 2, wherein the acrylic resin comprises a homopolymer or copolymer of methacrylic acid, an alkyl methacrylate, or a combination thereof.

13. The pressure sensitive adhesive sheet according to claim 12, wherein the acrylic resin comprises polymethyl methacrylate (PMMA).

14. The pressure sensitive adhesive sheet according to claim 2, wherein the polyvinyl chloride-based resin comprises polyvinyl chloride, ethylene-vinyl chloride copolymer, vinyl acetate-vinyl chloride copolymer, vinyl chloride-halogenated olefin copolymer, or a combination thereof.

15. The pressure sensitive adhesive sheet according to claim 2, wherein an average degree of polymerization of the polyvinyl chloride-based resin is from 500 to 5000.

16. The pressure sensitive adhesive sheet according to claim 1, wherein the hydrogen abstraction type photoinitiator comprises an aromatic ketone selected from the group consisting of acetophenone, benzophenone, P,P′-dimethoxybenzophenone, 4-methylbenzophenone, P,P′-dichlorobenzophenone, P,P′-dimethylbenzophenone, acetonapthone, and a combination thereof.

17. The pressure sensitive adhesive sheet according to claim 1, wherein the hydrogen abstraction type photoinitiator comprises an aromatic aldehyde or a quinone-based aromatic compound.
